(19) United States
(12) Patent Application Publication
(10) Pub. No.: US 2025/0361112 A1
(43) Pub. Date: Nov. 27, 2025

(54) MEDIUM PROCESSING APPARATUS AND IMAGE FORMING SYSTEM

(71) Applicant: Tsubasa HASHIMOTO, Kanagawa (JP)

(72) Inventor: Tsubasa HASHIMOTO, Kanagawa (JP)

(73) Assignee: Ricoh Company, Ltd., Tokyo (JP)

(21) Appl. No.: 19/199,772

(22) Filed: May 6, 2025

(30) Foreign Application Priority Data
May 23, 2024 (JP) 2024-084314

(51) Int. Cl. B65H 37/04; B41J 11/00; B65H 43/00; G03G 15/00

(52) U.S. Cl. CPC B65H 37/04; B41J 11/0015; B65H 43/00; G03G 15/6544; B65H 2301/5161; B65H 2301/5162; B65H 2801/27; G03G 2215/00801

(57) ABSTRACT

A medium processing apparatus includes a liquid applier to apply liquid to a medium, a post-processing device to perform post-processing on a plurality of media including the medium to which the liquid is applied by the liquid applier, a movement assembly to move the liquid applier and the post-processing device in a width direction of the medium, a first liquid storage on the liquid applier to store the liquid applied to the medium, a second liquid storage to store the liquid supplied to the first liquid storage, a liquid supply passage through which the liquid is supplied from the second liquid storage to the first liquid storage; and processing circuitry to control the movement assembly. The processing circuitry stops the movement assembly when a load of a driving source of the movement assembly exceeds a threshold.

### CROSS-REFERENCE TO RELATED APPLICATION

This patent application is based on and claims priority pursuant to 35 U.S.C. § 119(a) to Japanese Patent Application No. 2024-084314, filed on May 23, 2024, in the Japan Patent Office, the entire disclosure of which is hereby incorporated by reference herein.

### BACKGROUND

### Technical Field

The present disclosure relates to a medium processing apparatus and an image forming system.

### Related Art

Media processing apparatuses have been proposed that bind sheet-shaped media, on which images are formed by an image forming apparatus, into a bundle of media. Since sheets of paper are widely known as an example of sheet-shaped media, a “sheet bundle” that is a stack of sheets of paper is used as an example of a bundle of sheet-shaped media in the following description. From the viewpoint of saving resources and reducing environmental load, some medium processing apparatuses include a crimping device that can perform so-called “crimping” to pinch a sheet bundle by serrated binding teeth and press and deform the sheet bundle without using metal staples.

An increased number of sheets of the sheet bundle hamper the binding teeth in biting into the sheet bundle and may cause some sheets to peel off from the bound sheets. Thus, crimping has some difficulties in keeping the sheet bundle bound as appropriate. In order to increase the binding strength, for example, a medium processing apparatus that performs crimping includes a liquid applier that applies liquid in advance to a position on a sheet where the binding teeth contact the sheet, to allow the binding teeth to easily bite into a sheet bundle.

For example, in a case where the medium processing apparatus having the above-described configuration is used in a cold region, it is conceivable that a thermistor is mounted to detect the state of the liquid or, e.g., a heater heats the liquid in order to avoid a failure due to freezing of the liquid supplied to the liquid applier. However, in such a case, the size and cost of the medium processing apparatus may increase due to an increase in the number of components.

### SUMMARY

The present disclosure described herein provides a medium processing apparatus that includes a liquid applier to apply liquid to a medium, a post-processing device to perform post-processing on a plurality of media including the medium to which the liquid is applied by the liquid applier, a movement assembly to move the liquid applier and the post-processing device in a width direction of the medium, a first liquid storage on the liquid applier to store the liquid applied to the medium, a second liquid storage to store the liquid supplied to the first liquid storage, a liquid supply passage through which the liquid is supplied from the second liquid storage to the first liquid storage; and processing circuitry to control the movement assembly. The processing circuitry stops the movement assembly when a load of a driving source of the movement assembly exceeds a threshold.

The present disclosure described herein also provides an image forming system that includes an image forming apparatus and the medium processing apparatus. The image forming apparatus forms an image on media constituting the plurality of media. The medium processing apparatus performs the post-processing on the plurality of media on which the image is formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system.

FIG. 2 is a diagram illustrating an internal structure of a post-processing apparatus according to a first embodiment.

FIG. 3 is a schematic view of an edge binder viewed from an upstream side in a conveyance direction;

FIG. 4 is a schematic view of an edge binder viewed from a liquid applier in a main scanning direction;

FIGS. 5A and 5B are schematic diagrams illustrating a configuration of a crimper of an edge binder;

FIG. 6 is a diagram illustrating an edge binder according to a modification;

FIGS. 7A, 7B, and 7C are diagrams illustrating a liquid application crimper of an edge binder according to a modification;

FIGS. 8A, 8B, and 8C are diagrams illustrating a liquid applying operation and a crimping operation performed by the liquid application crimper of FIGS. 7A, 7B, and 7C;

FIG. 9 is a schematic view of a staple binder viewed from an upstream side in a conveyance direction;

FIG. 10 is a schematic view of a staple binder according to a modification, viewed from an upstream side in a conveyance direction;

FIG. 11 is a block diagram illustrating a hardware configuration of control of the post-processing apparatus according to the first embodiment to control the post-processing apparatus;

FIG. 12 is a flowchart of a binding process performed by an edge binder;

FIGS. 13A, 13B, and 13C are diagrams illustrating the positions of a liquid applier and a crimper during the binding process of FIG. 12;

FIGS. 14A and 14B are diagrams illustrating the arrangement and configuration of a second liquid storage in a post-processing apparatus;

FIG. 15 is a diagram illustrating a configuration of attachment and detachment of a second liquid storage in a post-processing apparatus;

FIG. 16 is a diagram illustrating an operation performed by a liquid applier according to the first embodiment;

FIG. 17 is an enlarged diagram illustrating another operation performed by the liquid applier according to the first embodiment;

FIG. 18 is a diagram illustrating yet another operation performed by the liquid applier according to the first embodiment;

FIG. 19 is a diagram illustrating yet another operation performed by the liquid applier according to the first embodiment;

FIG. 20 is a diagram illustrating yet another operation performed by the liquid applier according to the first embodiment;

FIGS. 21A and 21B are perspective views of an edge binder and a coil tube;

FIG. 22A is a diagram illustrating an example of the appearance of a cold region setting screen;

FIG. 22B is a diagram illustrating an example of the appearance of a freezing notification screen;

FIG. 22C is a diagram illustrating an example of the appearance of a jam notification screen;

FIG. 23 is a flowchart of an edge-binder moving process;

FIG. 24 is a graph illustrating an example of a change over time in the load (magnitude of th driving current) of an edge-binder movement motor in the edge-binder moving process of FIG. 23;

FIG. 25 is a diagram illustrating an internal configuration of a post-processing apparatus according to a second embodiment;

FIGS. 26A, 26B, and 26C are schematic views of an internal tray according to the second embodiment, viewed from a thickness direction of a sheet;

FIG. 27 is a schematic view of a crimper according to the second embodiment, viewed from a downstream side in a conveyance direction;

FIGS. 28A and 28B are schematic views of a liquid applier according to the second embodiment, viewed from a thickness direction of a sheet;

FIGS. 29A, 29B, and 29C are cross-sectional views of the liquid applier taken along a line XXV-XXV of FIG. 28A;

FIGS. 30A, 30B, and 30C are cross-sectional views of the liquid applier taken along a line XXVI-XXVI of FIG. 28A;

FIG. 31 is a block diagram illustrating a hardware configuration of control of the post-processing apparatus according to the second embodiment;

FIG. 32 is a flowchart of post-processing performed by the post-processing apparatus according to the second embodiment;

FIG. 33 is a diagram illustrating an overall configuration of an image forming system according to a modification;

FIGS. 34A and 34B are diagrams illustrating a post-processing apparatus including controllers according to a first modification; and

FIGS. 35A and 35B are diagrams each illustrating a post-processing apparatus including controllers according to a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. Note that identical parts are given identical reference signs and redundant descriptions are summarized or omitted accordingly. In the following description, a liquid discharge head that discharge ink as an exemplary liquid is described.

A description is given below of an image forming system 1 according to an embodiment of the present disclosure, with reference to the drawings.

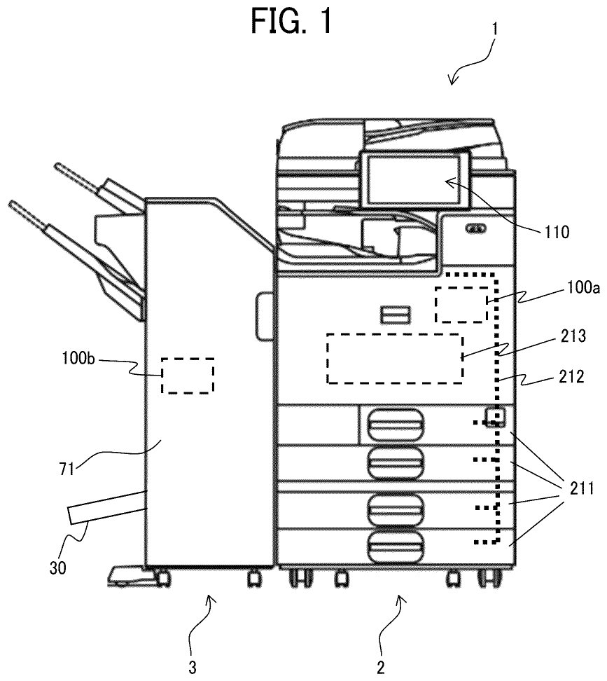

FIG. 1 is a diagram illustrating an overall configuration of the image forming system 1. The image forming system 1 has a function of forming an image on a sheet P as a sheet medium and a function of performing a post-processing operation on the sheet P as a process after the image is formed on the sheet P. As illustrated in FIG. 1, the image forming system 1 includes an image forming apparatus 2 having the image forming function and a post-processing apparatus 3 serving as a medium processing apparatus having the post-processing function according to an embodiment of the present disclosure. In the image forming system 1, the image forming apparatus 2 and the post-processing apparatus 3 operate in conjunction with each other.

In the present embodiment, the sheet-shaped medium to be processed in the image forming system 1 is assumed to be a sheet of “paper.” However, the object to be processed according to the present embodiment is not limited to a sheet of paper. For example, any type of medium can be used as long as an image can be formed on the medium according to an image forming process. Examples of the medium include a medium that can be an object of a folding process or a binding process, and the material and specification of the medium are not limited to any particular material and specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image forming device 213 may be an inkjet system that forms an image using an inkjet system or an electrophotographic system that forms an image with toner. The image forming apparatus 2 also includes a controller 100a that controls various operations of the conveyor 212 and the image forming device 213. Since the image forming apparatus 2 has a typical configuration, a detailed description of the configuration and functions of the image forming apparatus 2 are omitted.

Sheets of paper are widely known as an example of sheet-shaped media. In the following description, a sheet-shaped medium as a medium to be processed is referred to as a “sheet P.” Further, in the following description, a bundle of sheets of paper as a plurality of media is an example of a “sheet bundle Pb.”

A description is given below of the post-processing apparatus 3 according to a first embodiment.

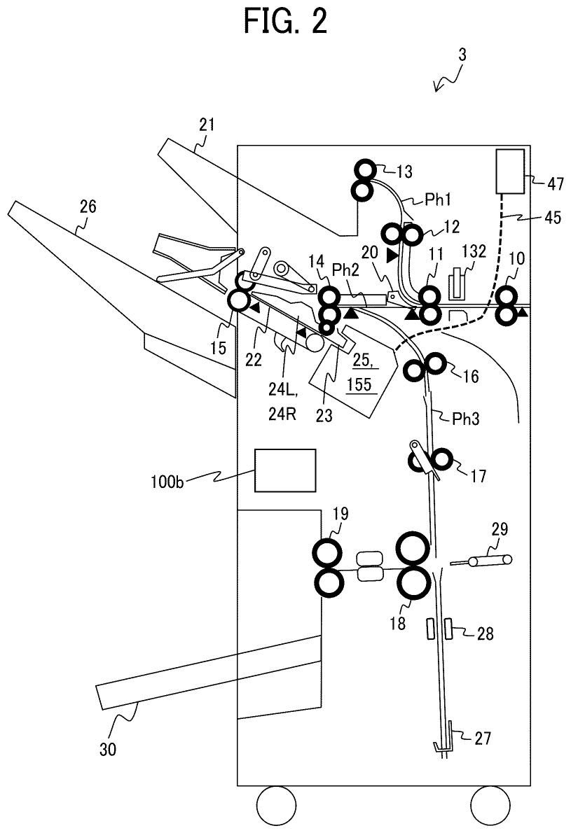

FIG. 2 is a diagram illustrating an internal structure of the post-processing apparatus 3 according to the first embodiment. The post-processing apparatus 3 has a function that performs post-processing on the sheet P on which an image has been formed by the image forming apparatus 2. An example of the post-processing according to the present embodiment is a binding process as a “crimping process” that binds, without staples, a plurality of sheets P on each of which an image is formed as a bundle of sheets, which may be referred to as a sheet bundle. Another example of the post-processing according to the present embodiment is a binding process as a “stapling process” that binds, with staples, a plurality of the sheets P on each of which an image is formed as a bundle of sheets P (i.e., sheet bundle). In the following description, the bundle of sheets may be referred to as a “sheet bundle Pb” as a bundle of media.

In the present embodiment, a description is given of liquid application in a crimping process. However, liquid application performed in a stapling process is similar to the liquid application in the crimping process. In the following description, the term “binding process” indicates both the “crimping process” and the “stapling process”, and is not limited to a binding method (whether a binding needle is used or a pressing and deforming process is performed).

More specifically, the “crimping process” according to the present embodiment is a process called “crimping” to apply pressure to the binding position corresponding to a part of a sheet stack Pb to deform (pressure-deform) the binding position and bind the sheet stack Pb. The binding that can be executed by the post-processing apparatus 3 includes edge binding and saddle binding. The edge binding is a process to bind an end (including an edge) of the sheet stack Pb. The saddle binding is a process to bind the center of the sheet stack Pb.

The post-processing apparatus 3 includes conveyance roller pairs 10 to 19 (an example of conveyors), a switcher 20, and a controller 100b (an example of a control device). The controller 100b controls the operations of, for example, the conveyance roller pairs 10 to 19 (an example of conveyors), and the switcher 20. Details of the controller 100b will be described below. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on the sheet P conveyed by the conveyance roller pairs 10 and 11.

The first conveyance passage Ph1 is a passage extending to an ejection tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to an ejection tray 26 via an internal tray 22. The third conveyance passage Ph3 is a passage branching from the first conveyance passage Ph1 between the conveyance roller pairs 11 and 14 in the conveyance direction and extending to an ejection tray 30.

The switcher 20, which is an example of a switcher, is disposed at a branching position of the first conveyance passage Ph1 and the second conveyance passage Ph2. The switcher 20 can be switched between a first position and a second position. The switcher 20 in the first position guides the sheet P to be ejected to the ejection tray 21 through the first conveyance passage Ph1. The switcher 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the multiple sensors is indicated by a black triangle in FIG. 2.

The post-processing apparatus 3 further includes the ejection tray 21. The sheet P that is output through the first conveyance passage Ph1 is placed on the ejection tray 21. Among the sheets P supplied from the image forming apparatus 2, a sheet P not subjected to the binding process is ejected to the ejection tray 21.

The post-processing apparatus 3 further includes the internal tray 22 serving as a placement tray, an end fence 23, side fences 24L and 24R, an edge binder 25, a staple binder 155, and an ejection tray 26. The internal tray 22, the end fence 23, the side fences 24L and 24R, the edge binder 25, and the staple binder 155 perform edge binding on the sheet bundle Pb including the multiple sheets P conveyed from the second conveyance path Ph2 to the internal tray 22. Among the sheets P supplied from the image forming apparatus 2, the sheet bundle Pb subjected to the edge binding is ejected to the ejection tray 26.

Examples of the “edge binding process” include, but not limited to, “parallel binding process,” “oblique binding process,” and “vertical binding process.” The “parallel binding process” is a process of binding the sheet bundle Pb along one side of the sheet bundle Pb parallel to the main scanning direction. The “oblique binding process” is a process of binding a corner of the sheet bundle Pb. The “vertical binding process” is a process of binding the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction.” In other words, the “conveyance direction” herein corresponds to a direction in which the sheet P that has been output from the image forming apparatus 2 is moved toward the ejection tray 26 by, for example, the conveyance roller pair 10, is changed to move toward the end fence 23 by the conveyance roller pair 15 in a direction different from the above-described direction. A direction orthogonal to the thickness direction and the transport direction of the paper P is defined as a “main scanning direction” or a “width direction”.

The sheets P that are sequentially conveyed through the second conveyance passage Ph2 are temporarily placed on the internal tray 22 serving as a placement tray. The end fence 23 aligns the position, in the conveyance direction, of the sheet P or the sheet stack Pb placed on the internal tray 22. The side fences 24L and 24R align the position, in the main scanning direction, of the sheet P or the sheet stack Pb placed on the internal tray 22. The edge binder 25 and the staple binder 155 bind an end of the sheet bundle Pb aligned by the end fence 23 and the side fences 24L and 24R. The conveyance roller pair 15 ejects the sheet bundle Pb subjected to the edge binding to the ejection tray 26.

The post-processing apparatus 3 further includes an end fence 27, a saddle binder 28, a sheet folding blade 29, and the ejection tray 30. The end fence 27, the saddle binder 28, and the sheet folding blade 29 perform the saddle binding on the sheet stack Pb of the sheets P that are conveyed through the third conveyance passage Ph3. Among the sheets P supplied from the image forming apparatus 2, the sheet bundle Pb subjected to the saddle binding is ejected to the ejection tray 30.

The end fence 27 aligns the positions of the sheets P that are sequentially conveyed through the third conveyance passage Ph3, in a conveyance direction in which the sheets P are conveyed. The end fence 27 can move between a binding position where the end fence 27 causes the center of the sheet stack Pb to face the saddle binder 28 and a folding position where the end fence 27 causes the center of the sheet stack Pb to face the sheet folding blade 29. The saddle binder 28 binds the center of the sheet stack Pb aligned by the end fence 27 at the binding position. The sheet folding blade 29 folds, in half, the sheet stack Pb placed on the end fence 27 at the folding position and causes the conveyance roller pair 18 to nip the sheet stack Pb. The conveyance roller pairs 18 and 19 eject the sheet bundle Pb subjected to the saddle binding to the ejection tray 30.

In addition, the post-processing apparatus 3 includes a liquid application member 501 (a part of the liquid applier), a liquid supply member 50 (a part of the liquid applier), and a first liquid storage tank 44 (a first liquid storage) in the edge binder 25. The first liquid storage tank 44 and the liquid supply member 50 are omitted in FIG. 2. The post-processing apparatus 3 includes a liquid supply passage 45 (a part of the liquid supplier), a liquid supply pump 46 (a part of the liquid supplier), a second liquid storage tank 47 (a part of the second liquid storage unit), and a second-liquid-storage-tank fixer 61 (a part of the second liquid storage unit) as a configuration for replenishing the first liquid storage tank 44 with the liquid. The liquid that is stored in the second liquid storage tank 47 is supplied to the first liquid storage tank 44 via the second-liquid-storage-tank fixer 61, the liquid supply pump 46, and the liquid supply passage 45.

A detailed description is given below of the edge binder 25.

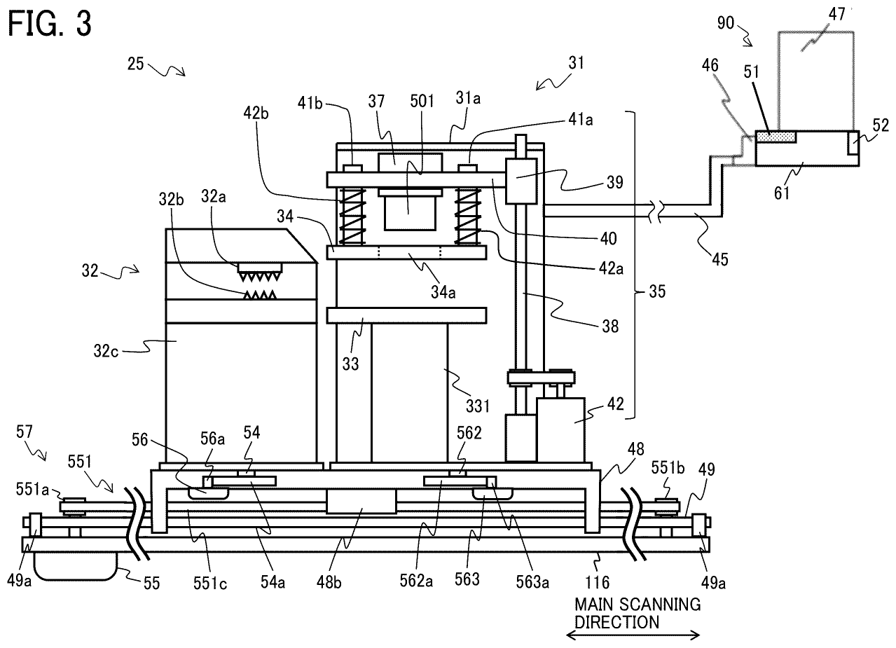

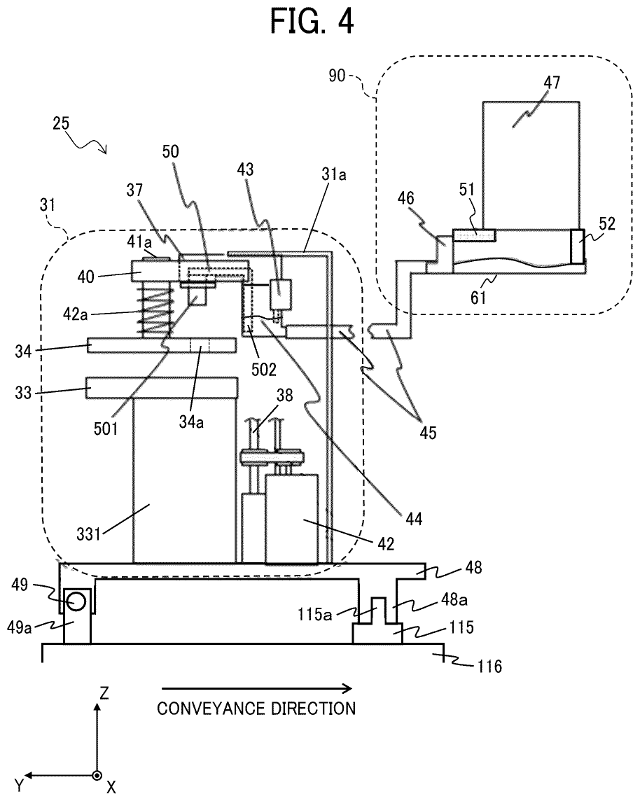

FIG. 3 is a schematic diagram illustrating an upstream side of the edge binder 25 in the conveyance direction. The edge binder 25 performs liquid application and crimping illustrated in FIG. 2. FIG. 4 is a schematic view of a liquid applier 31 of the edge binder 25 in the main scanning direction. As illustrated in FIG. 3, the edge binder 25 includes a liquid applier 31 that applies liquid to the sheets P, and a crimper 32 that is an example of a post-processing device and performs crimping binding on the sheet bundle Pb. The liquid applier 31 and the crimper 32 are disposed adjacent to each other in the main scanning direction downstream from the internal tray 22 in the conveyance direction.

As illustrated in FIG. 4, the liquid applier 31 applies the liquid stored in the first liquid storage tank 44 to the sheet P or the sheet bundle Pb placed on the internal tray 22. Applying liquid to a sheet P or a sheet bundle Pb by the liquid applier 31 and the operation of the liquid applier 31 when applying liquid are referred to as “liquid application”. The liquid application operation of the liquid applier 31 accompanied by the control process is referred to as a “liquid application process.”

More specifically, the liquid that is stored in the first liquid storage tank 44 for the liquid application includes, as a main component, the liquid state of a compound of hydrogen and oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 44 may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

As illustrated in FIGS. 3 and 4, the liquid applier 31 can be moved in the main scanning direction together with the crimper 32 by the driving force transmitted from the edge-binder movement motor 55. The liquid applier 31 includes a lower pressure plate 33 as a sheet stacking table of the sheet P or the sheet bundle Pb, an upper pressure plate 34, and a liquid-applier movement assembly 35. The components of the liquid applier 31 (the lower pressure plate 33, the upper pressure plate 34, the liquid-applier movement assembly 35, and the liquid-applier movement motor 42) are held by the liquid application frame 31a and the base 48.

A liquid applier shaft 562 provided with a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of the liquid-applier pivot motor 563. The liquid applier 31 can be rotated in the forward and reverse directions about the liquid applier shaft 562 on the base 48 by a driving force transmitted from the liquid-applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 is provided with a through hole 34a passing through the upper pressure plate 34 in the thickness direction at a position opposite to the liquid application member 501 held via a holder 37 attached to a base plate 40. The liquid application member 501 is one end portion of a liquid supply member 50 (liquid absorber) described below and corresponds to a tip portion of the liquid supply member 50.

The liquid-applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid-applier movement assembly 35 according to the embodiment moves the upper pressure plate 34, the base plate 40, the holder 37, the liquid application member 501, the liquid supply member 50, and the first liquid storage tank 44 in conjunction with each other by the single liquid-applier movement motor 42. The liquid-applier movement assembly 35 includes, for example, the liquid-applier movement motor 42, a trapezoidal screw 38, a nut 39, the base plate 40, columns 41a and 41b, and coil springs 42a and 42b.

The liquid-applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet stack Pb and is provided with the liquid application frame 31a such that the trapezoidal screw 38 is rotatable in the forward and reverse directions. The trapezoidal screw 38 is coupled to an output shaft of the liquid-applier movement motor 42 via, for example, a pulley and a belt. The nut 39 is screwed to the trapezoidal screw 38. The trapezoidal screw 38 is rotated in the forward and reverse directions by the driving force transmitted from the liquid-applier movement motor 42. The rotation of the trapezoidal screw 38 causes the nut 39 to reciprocate on the trapezoidal screw 38.

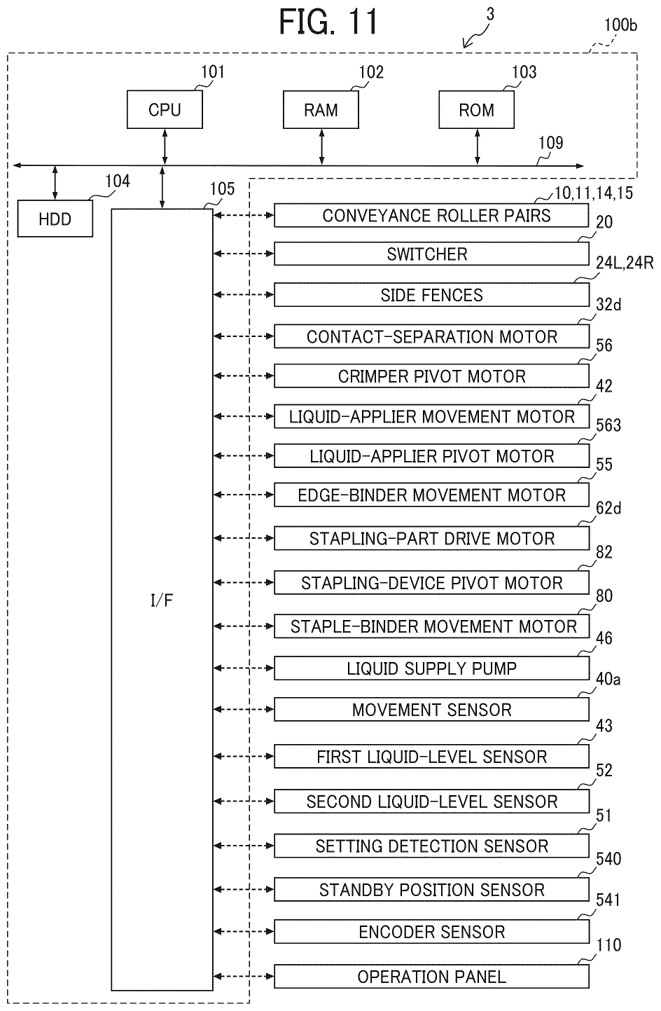

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the vertical direction is detected by a movement sensor 40a (see FIG. 11).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More specifically, the liquid applier 31 brings the liquid application member 501 into contact with the sheet P or the sheet bundle Pb to apply the liquid to at least one sheet P of the sheet bundle Pb.

The liquid applier 31 includes the first liquid-level sensor 43 (an example of a first liquid detector), the first liquid storage tank 44, the liquid application member 501, the liquid supply member 50, and the holder 37. The first liquid storage tank 44 stores the liquid to be applied to the sheet P or the sheet stack Pb. The amount of liquid that is stored in the first liquid storage tank 44 is detected by the first liquid-level sensor 43. The first liquid storage tank 44 is coupled to the base plate 40 via the holder 37.

The liquid application member 501, the liquid supply member 50 disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion that sucks up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the other end portion (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from a liquid immersion portion 502 of the liquid supply member 50, and the sucked liquid is supplied to the liquid application member 501 that is coupled to the tip portion via the liquid supply member 50. Then, the liquid stored in the first liquid storage tank 44 is drawn up to the liquid application member 501 in close contact with one end portion of the liquid supply member 50, and thus the liquid level (stored liquid amount) of the liquid stored in the first liquid storage tank 44 detected by the first liquid-level sensor 43 is lowered. As a result, the liquid is supplied from the second liquid storage tank 47 to the first liquid storage tank 44 by the liquid supply pump 46. The liquid supply operation including the operation of filling the liquid stored in the first liquid storage tank 44 by sucking the liquid by the liquid supply member 50 and supplying the liquid to the liquid application member 501 in this manner is referred to as a filling supply operation.

Although the case where the liquid supply member 50 and the liquid application member 501 are separate bodies has been described above, the liquid supply member 50 and the liquid application member 501 may be integrally formed of a material having the same properties (e.g., a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

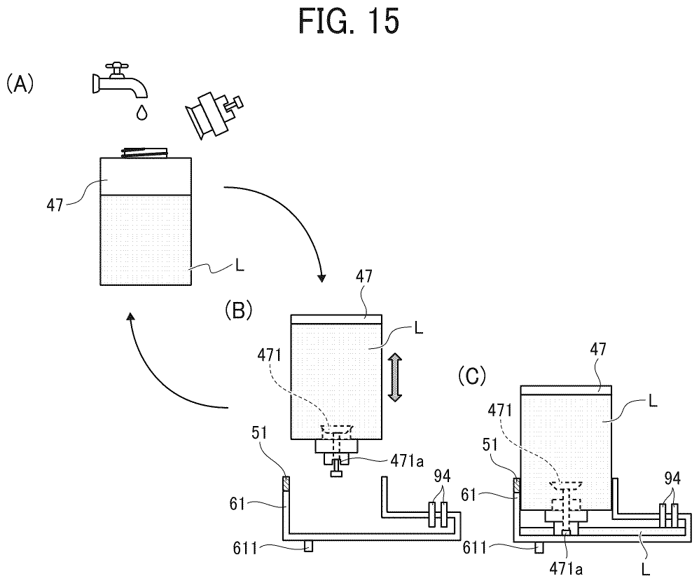

The edge binder 25 is coupled to the second liquid storage tank 47. The second liquid storage tank 47 is detachably attached to the edge binder 25 or the post-processing apparatus 3 (see FIG. 15). The second liquid storage tank 47 is fixed (set) to the second-liquid-storage-tank fixer 61 (a part of the second liquid storage unit) at a given position. By so doing, the liquid already stored in the second liquid storage tank 47 can be supplied to the first liquid storage tank 44.

The operation of supplying liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 decreases as the liquid is consumed by the liquid application by the liquid applier 31. In other words, the operation to supply liquid from the second liquid storage tank 47 to the first liquid storage tank 44 corresponds to the liquid supplying operation in accordance with the execution of the job including liquid application by the liquid applier 31.

This liquid supply operation corresponds to an operation of supplying liquid to the first liquid storage tank 44 so as to replenish liquid each time the stored liquid amount (liquid level) of the first liquid storage tank 44 falls below a reference liquid level, which is described below. In the following description, the liquid supplying operation is referred to as a “replenishing operation.”

The above-described “reference liquid level” indicates a liquid level (a stored liquid amount in the first liquid storage tank 44) when the first liquid-level sensor 43 detects the liquid in the first liquid storage tank 44.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a setting detection sensor 51 (an example of a setting detector) (see FIG. 15). When the setting detection sensor 51 detects the set state of the second liquid storage tank 47 to the second-liquid-storage-tank fixer 61 (see part (C) of FIG. 15), a signal indicating the set state is transmitted to the controller 100b, which is described below. Thus, the controller 100b to be described below detects whether the second liquid storage tank 47 is mounted to the second-liquid-storage-tank fixer 61. Details of the second liquid storage tank 47 will be described below.

The first liquid storage tank 44 and the second liquid storage tank 47 are coupled to each other by the liquid supply passage 45. The liquid supply pump 46 is disposed near the second-liquid-storage-tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second-liquid-storage-tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid-applier movement assembly 35, liquid can be supplied from the second liquid storage tank 47 to the first liquid storage tank 44 reliably.

The supply of liquid from the second liquid storage tank 47 to the first liquid storage tank 44 can be controlled in accordance with the detection result of the first liquid-level sensor 43. In other words, the controller 100b, which is described below, determines whether the stored liquid amount (liquid level) in the first liquid storage tank 44 based on the detection result of the first liquid-level sensor 43. In accordance with the determined stored liquid amount (liquid level) of the first liquid storage tank 44, the controller 100b controls the operation speed and time of the liquid supply pump 46. Thus, the controller 100b can adjust the amount of liquid to be replenished to the first liquid storage tank 44 to maintain the liquid amount (liquid level) in the first liquid storage tank 44 at a constant amount (level).

A description is given of the configuration of the crimper 32.

The crimper 32 serving as a post-processing device presses and deforms a portion of the sheet bundle Pb by serrated upper crimping teeth 32a and lower crimping teeth 32b, and crimps the sheets P of the portion to bind the sheet bundle Pb. In short, the crimper 32 binds the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimping.” In other words, the crimper 32 crimps and binds the sheet bundle Pb or performs the crimping on the sheet bundle Pb. The crimping and binding operation of the crimper 32 that involves control processing is referred to as “crimping process”.

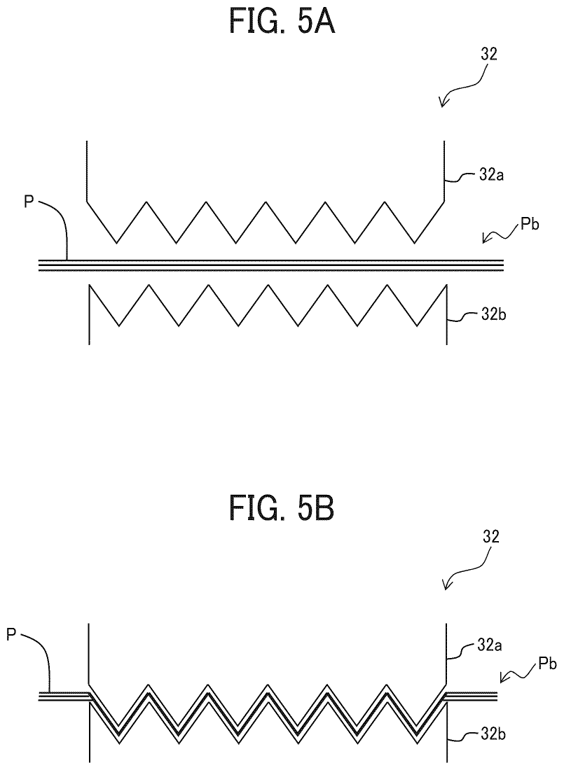

FIGS. 5A and 5B are schematic diagrams illustrating a configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet stack Pb to sandwich the sheet stack Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by a driving force of a contact-separation motor 32d illustrated in FIG. 11.

In the process of supplying the multiple sheets P of the sheet bundle Pb to the internal tray 22, as illustrated in FIG. 5A, the upper crimping teeth 32a and the lower crimping teeth 32b are separated from each other. When all the sheets P of the sheet stack Pb are placed on the internal tray 22, the upper crimping teeth 32a and the lower crimping teeth 32b are engaged with each other as illustrated in FIG. 5B by the driving force of the contact-separation motor 32d to press and deform the sheet stack Pb in the thickness direction. As a result, the sheet bundle Pb that has been placed on the internal tray 22 is crimped and bound. The sheet bundle Pb thus crimped and bound is ejected to the ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge-binder movement assembly 57. The edge-binder movement assembly 57 moves the edge binder 25, specifically, the liquid applier 31 and the crimper 32, in the main scanning direction along a downstream end, in the conveyance direction, of the sheet P placed on the internal tray 22. The edge-binder movement assembly 57 includes, for example, the base 408, a guide shaft 49, the edge-binder movement motor 55, and a driving force transmission assembly 551 that transmits the driving force of the edge-binder movement motor 55 to the base 48, and a standby position sensor 540 (see FIG. 11).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction of the sheet P. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge-binder movement motor 55 generates a driving force to move the edge binder 25. The driving force transmission assembly 551 transmits the driving force of the edge-binder movement motor 55 to the base 48 via pulleys 551a and 551b, a timing belt 551c, and a fastening portion 48b that fastens the base 408 and the timing belt 551c. As a result, the liquid applier 31 and the crimper 32 integrated by the base 408 move in the main scanning direction along the guide shaft 49.

The edge-binder movement motor 55 according to the present embodiment is, for example, a servo motor that can stop the edge binder 25 at a target position (e.g., a binding position B1 described below) without returning the edge binder 25 to an origin position (e.g., a standby position HP described below) every time the edge binder 25 is moved.

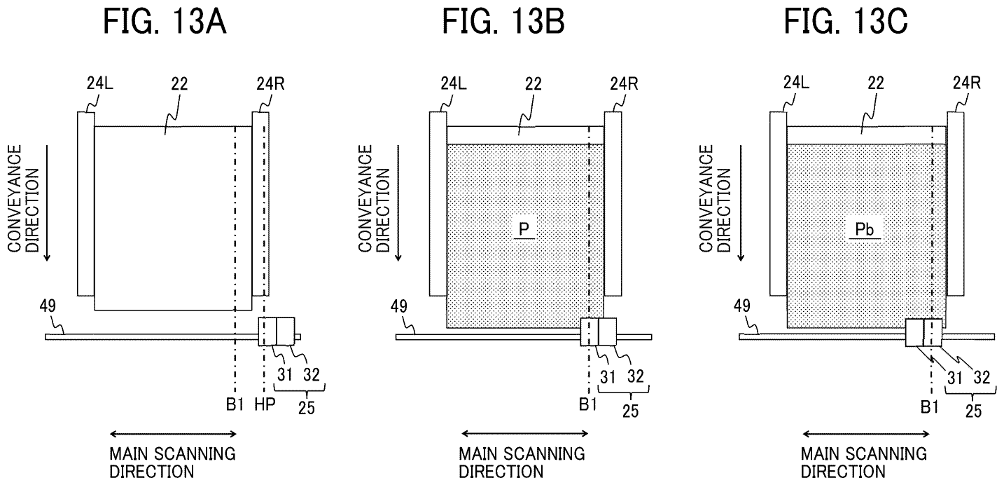

The post-processing apparatus 3 further includes a standby position sensor 540 and an encoder sensor 541. The standby position sensor 540 is, for example, a light-shielding optical sensor (see FIG. 11) to detect that the edge binder 25 has reached a standby position HP (see FIG. 13A). The encoder sensor 541 (see FIG. 11) is attached to an output shaft of the edge-binder movement motor 55. The controller 100b, which is described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper rotary shaft 54 provided with a drive transmission gear 54a is fixed to a bottom face of the crimping frame 32c that holds the components of the crimper 32. The crimper rotary shaft 54 and the drive transmission gear 54a are held by a base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper rotary shaft 54 on the base 48 by a driving force transmitted from the crimper pivot motor 56 to the crimper rotary shaft 54 via the output gear 56a and the drive transmission gear 54a.

In the above description, the edge binder 25 has a configuration of moving along the guide shaft 49 with the crimper 32 and the liquid applier 31 being integrated, the configuration of the edge binder is not limited to the above-described configuration. For example, the crimper 32 and the liquid applier 31 may have a configuration of moving separately from each other.

A description is given below of an edge binder 25′ according to a modification.

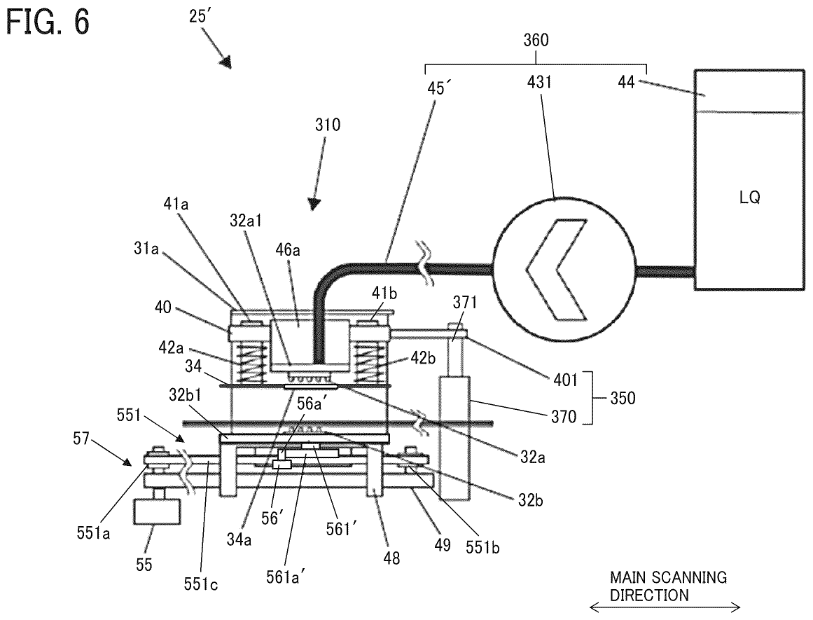

Specifically, referring now to FIGS. 6 to 8C, a description is given of an edge binder 25′ as a modification of the edge binder 25 included in the post-processing apparatus 3. A difference of the edge binder 25′ from the edge binder 25 according to the first embodiment is that the liquid applier 31 and the crimper 32 are integrated as a single unit. In the following description, identical or similar components to those of the edge binder 25 according to the first embodiment are denoted by identical or similar reference numerals, and redundant descriptions thereof may be omitted.

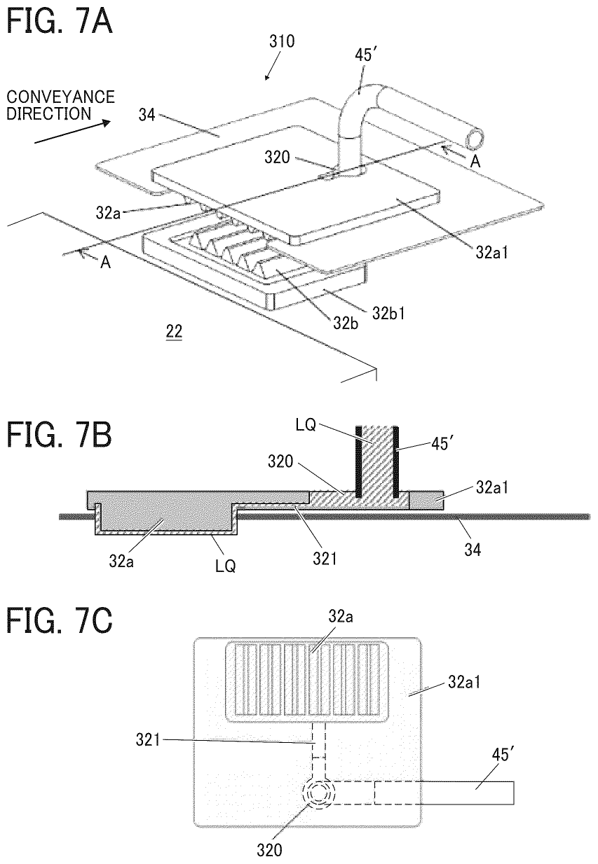

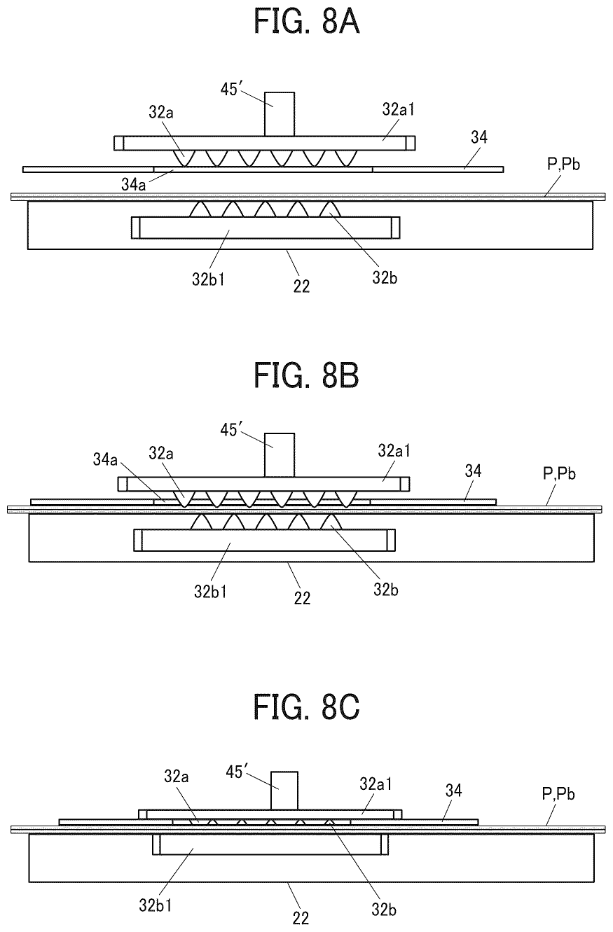

FIG. 6 is a schematic view of the edge binder 25′ viewed from the upstream side in the conveyance direction. FIG. 7A is a perspective view of a liquid application crimper 310. FIG. 7B is a cross-sectional view of the liquid application crimper 310 taken along line A-A in FIG. 7A. FIG. 7C is a plan view of the upper crimping teeth 32a of FIG. 7A as viewed from the side at which the lower crimping teeth 32b is disposed. FIGS. 8A, 8B, and 8C illustrate a liquid application operation and a crimping operation performed by the liquid application crimper 310 and are schematic views of the liquid application crimper 310 viewed from the downstream side in the conveyance direction.

As illustrated in FIG. 6, the edge binder 25′ includes the liquid application crimper 310 in which the liquid applier 31 and the crimper 32 (serving as a post-processing device) of the edge binder 25 according to the first embodiment are integrated as a single unit. The liquid application crimper 310 is disposed downstream from the internal tray 22 in the conveyance direction.

The liquid application crimper 310 applies liquid LQ stored in the first liquid storage tank 44 to the sheet P or the sheet bundle Pb placed on the internal tray 22. The liquid application crimper 310 can be moved in the main scanning direction by the driving force that is transmitted from the edge-binder movement motor 55 to the base 48 by the driving force transmission assembly 551. The liquid application crimper 310 includes the upper pressure plate 34, the upper crimping teeth 32a, the lower crimping teeth 32b, a liquid-application-crimper movement assembly 350, and a liquid supply assembly 360. Components of the liquid application crimper 310 are held by the liquid application frame 31a and the base 48. A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a liquid application crimper pivot motor 56′. The liquid application crimper 310 can be rotated in the forward and reverse directions about the liquid application crimper shaft 561′ on the base 48 by a driving force transmitted from the liquid application crimper pivot motor 56′ to the liquid application crimper shaft 561′ via the output gear 56a′ and the drive transmission gear 561a′.

The liquid-application-crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds the upper crimping teeth holder 32al and the upper crimping teeth 32a via a holder 46a. The base plate 40 movably holds the upper pressure plate 34 via the columns 41a and 41b. The base plate 40 is attached to the distal end of a rod 371 of the electric cylinder 370 via a connecter 401.

The columns 41a and 41b hold the upper pressure plate 34 at lower ends of the columns 41a and 41b. The coil springs 42a and 42b are externally inserted into the columns 41a and 41b between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 44, a liquid supply pump 431, and a first liquid supply passage 45′. The liquid supply pump 431 supplies the liquid LQ to the liquid reservoir 320 disposed in the upper crimping teeth holder 32al as illustrated in FIG. 7A via the first liquid supply passage 45′. The first liquid supply passage 45′ is coupled to the liquid supply pump 431 at the base end and to the liquid reservoir 320 at the tip end. The first liquid supply passage 45′ includes a long and elastic member.

As illustrated in FIG. 7B, the upper crimping teeth 32a are integrated with the upper crimping teeth holder 32al. The upper crimping teeth holder 32al is provided with the liquid reservoir 320 and a liquid supply passage 321 for supplying the liquid LQ stored in the liquid reservoir 320 to the upper crimping teeth 32a. The surface of the upper crimping teeth 32a is subjected to a hydrophilic treatment so that the liquid LQ that is supplied through the liquid supply passage 321 uniformly spreads over the surface of the upper crimping teeth 32a. On the other hand, the portions of the upper crimping teeth holder 32al other than the upper crimping teeth 32a are subjected to a hydrophobic treatment so that the liquid LQ efficiently spreads over the surfaces of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

A description is given below of the liquid application operation and the crimping operation of the liquid application crimper 310 with reference to FIGS. 8A, 8B, and 8C. In the process of supplying a sheet P to the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first comes into contact with the sheet P, and then the upper crimping teeth 32a pass through the through-hole 34a of the upper pressure plate 34 and come into contact with the sheet P. At this time, since the liquid LQ is spread over the surfaces of the upper crimping teeth 32a, bringing the upper crimping teeth 32a into contact with the sheet P allows the liquid to be applied to the liquid application position on the sheet P. When liquid application to the liquid application position is completed, the electric cylinder 370 is extended to separate the upper crimping teeth 32a and the upper pressure plate 34 from the sheet P. The above-described contact and separation operation (liquid application operation) of the upper crimping teeth 32a and the upper pressure plate 34 with respect to the sheets P is repeatedly performed on sheets P of the sheet bundle Pb.

When the sheet bundle Pb including a predetermined number of sheets P is placed on the internal tray 22, the electric cylinder 370 is further contracted to move the upper crimping teeth 32a toward the lower crimping teeth 32b. Then, as illustrated in FIG. 8C, in a state in which the sheet bundle Pb is sandwiched between the upper crimping teeth 32a and the lower crimping teeth 32b, the upper crimping teeth 32a further moves toward the lower crimping teeth 32b. Thus, the upper crimping teeth 32a and the lower crimping teeth 32b press and deform the sheet bundle Pb to crimp and bind the sheet bundle Pb (crimping operation).

A description is given of a staple binder 155.

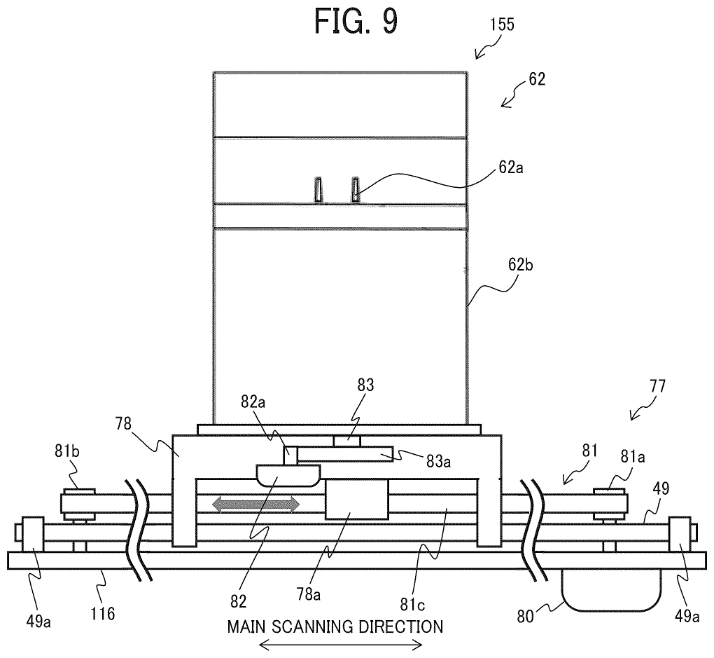

Specifically, a detailed description is given below of the staple binder 155 having a function of executing a stapling process. FIG. 9 is a schematic diagram illustrating the staple binder 155, viewed from the upstream side of the staple binder 155 in the conveyance direction. The staple binder 155 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 serving as a post-processing device has a configuration of performing so-called “staple binding” to bind a sheet bundle Pb with a staple(s). More specifically, the stapler 62 includes a stapling-part drive motor 62d (see FIG. 11) that drives the stapling part 62a. The stapling part 62a binds the sheet bundle Pb by causing the binding staple loaded in the stapling part 62a to penetrate the sheet bundle Pb by the driving force of the stapling-part drive motor 62d. The configuration of the stapler 62 is already known, and thus detailed description thereof will be omitted.

As illustrated in FIG. 9, the staple binder 155 includes a staple-binder movement assembly 77. The staple-binder movement assembly 77 moves the staple binder 155 in the main scanning direction along a downstream end in the conveyance direction of the sheet P or the sheet bundle Pb placed on the internal tray 22. The staple-binder movement assembly 77 includes, for example, a base 78, the guide shaft 49, a staple-binder movement motor 80, and a driving force transmission assembly 81. The driving force transmission assembly 81 transmits a driving force of the staple-binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge-binder movement assembly 57 and the staple-binder movement assembly 77 move the edge binder 25 and the staple binder 155 in the main scanning direction along the common guide shaft 49. The edge-binder movement assembly 57 and the staple-binder movement assembly 77 can independently move the edge binder 25 and the staple binder 155.

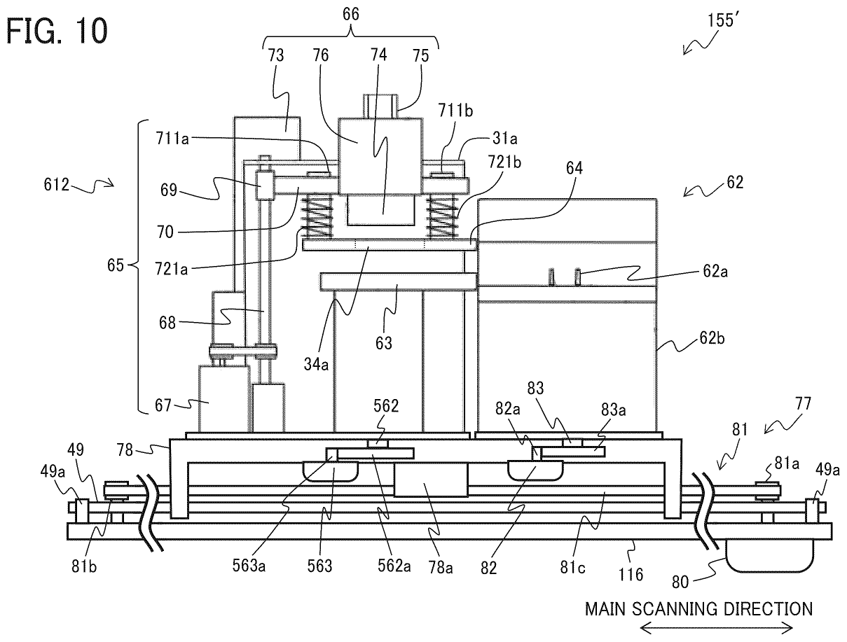

FIG. 10 illustrates a staple binder 155′ as a modification of the staple binder 155. Specifically, FIG. 10 is a view of an upstream side of the staple binder 155′ in the conveyance direction. The staple binder 155′ is different from the staple binder 155 in that the staple binder 155′ includes a second liquid applier 612 in addition to the stapler 62. As illustrated in FIG. 10, the staple binder 155′ includes the second liquid applier 612 and the stapler 62. The second liquid applier 612 and the stapler 62 are disposed adjacent to each other in the main scanning direction on the downstream side of the internal tray 22 in the conveyance direction.

The second liquid applier 612 executes “liquid application” of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 10, the second liquid applier 612 includes a second lower pressure plate 63, a second upper pressure plate 64, a second liquid-applier movement assembly 65, and a second liquid application assembly 66. The second liquid-applier movement assembly 65 includes, for example, a second liquid-application-unit movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid application member 74, a second liquid supply portion 75, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required. Since the configuration of the stapler 62 illustrated in FIG. 10 is like the configuration of the stapler 62 illustrated in FIG. 9, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes a liquid-applier pivot motor 563, an output gear 563a, a drive transmission gear 562a, and a liquid applier shaft 562.

In the binding process, the staple binder 155′ that is illustrated in FIG. 10 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without performing the liquid application.

A description is given below of a control block of the post-processing apparatus 3.

A description is given below of a control block of the post-processing apparatus 3, with reference to FIG. 11. FIG. 11 is a block diagram illustrating a hardware configuration for executing control processing in the post-processing apparatus 3. As illustrated in FIG. 11, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b, which is an example of a control device, to control the operation of the post-processing apparatus 3.

The I/F 105 is an interface that connects the conveyance roller pairs 10, 11, 14, and 15, the switcher 20, the side fences 24L and 24R, the contact-separation motor 32d, the crimper pivot motor 56, the liquid-applier movement motor 42, the liquid-applier pivot motor 563, the edge-binder movement motor 55, the stapling-part drive motor 62d, the stapler pivot motor 82, the staple-binder movement motor 80, the liquid supply pump 46, the movement sensor 40a, the first liquid-level sensor 43, the second liquid-level sensor 52 serving as a second liquid amount detector, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switcher 20, the side fences 24L and 24R, the contact-separation motor 32d, the crimper pivot motor 56, the liquid-applier movement motor 42, the liquid-applier pivot motor 563, the edge-binder movement motor 55, the stapling-part drive motor 62d, the stapler pivot motor 82, the staple-binder movement motor 80, and the liquid supply pump 46. The controller 100b acquires detection results from the movement sensor 40a, the first liquid-level sensor 43, the second liquid-level sensor 52, the setting detection sensor 51, the standby position sensor 540, and the encoder sensor 541.

Although FIG. 11 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation section and provides information to the user through the display. A specific example of the notifier is not limited to the display and may be a light-emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

The liquid application executed by the post-processing apparatus 3 may be performed by the staple binder 155 including the stapler 62 only, and the liquid application may be performed by using the liquid applier 31 included in the edge binder 25. On the other hand, the edge binder 25 may include only the crimper 32, and the liquid application may be performed by using the second liquid applier 612. In other words, the post-processing apparatus 3 may have a configuration in which either one of the liquid applier 31 and the second liquid applier 612 performs the liquid application, regardless of the type of the binding process.

In the above description, the staple binder 155′ has a configuration in which the stapler 62 and the second liquid applier 612 move along the guide shaft 49 as a single unit. However, the configuration of the staple binder is not limited to the above-described configuration. For example, the stapler 62 and the second liquid applier 612 may move separately.

A description is given below of a binding process.

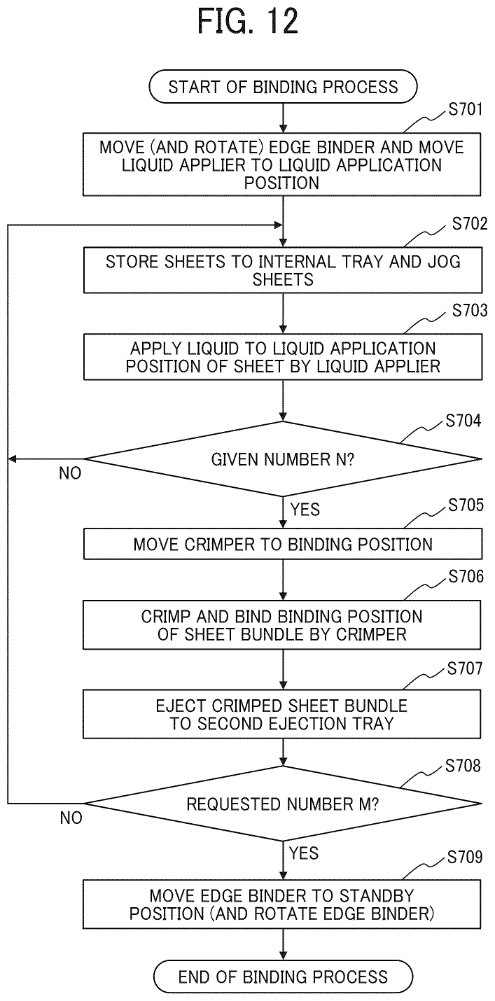

Specifically, a description is given below of a binding process executed by the edge binder 25 included in the post-processing apparatus 3. FIG. 12 is a flowchart of a process of a one-point binding performed by the edge binder 25. FIGS. 13A, 13B, and 13C are diagrams each illustrating the positions of the edge binder 25 (the liquid applier 31 and the crimper 32) during the one-point binding. FIGS. 13A, 13B, and 13C do not illustrate changes in the postures of the liquid applier 31 and the crimper 32. The position (liquid application position) to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are described with the same reference sign (B1).

For example, the controller 100b starts the binding process illustrated in FIG. 9 when the controller 100b acquires an instruction to execute the binding process from the image forming apparatus 2. In the following description, the instruction to execute the binding process may be referred to as a “binding command.”

The binding command includes, for example, the type of the sheet P (i.e., information affecting the spread of liquid, such as material and thickness), the number of sheets P of the sheet stack Pb, the number of sheet stacks Pb to be bound, the binding position on the sheet stack Pb, and the binding posture of the edge binder 25. In the following description, the number of sheets P of the sheet stack Pb may be referred to as “given number of sheets N” whereas the number of sheet stacks Pb to be bound may be referred to as “requested number of copies M.” The liquid applier 31 and the crimper 32 are assumed to be in a parallel binding posture and located at a standby position HP (FIG. 13A) that is a position shifted in the width direction from the sheets P placed on the internal tray 22 at the start of the binding process.

When the posture that is instructed by the binding command is the “oblique binding posture,” in step S701, the controller 100b drives the liquid-applier pivot motor 563 and the crimper pivot motor 56 to rotate the liquid applier 31 and the crimper 32 of the edge binder 25 into the oblique binding posture. Alternatively, when the posture that is instructed by the binding command is the “oblique binding posture,” only the crimper 32 may be rotated to the oblique binding posture while the liquid applier 31 may not be rotated. Such a configuration can simplify the drive mechanism as compared with a configuration in which both the liquid applier 31 and the crimper 32 are rotated in the forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b omits the aforementioned operation of rotating the liquid applier 31 and the crimper 32 of the edge binder 25 to the oblique binding posture.

In step S701, the controller 100b drives the edge-binder movement motor 55 to move the edge binder 25 in the main scanning direction so that the liquid applier 31 faces the liquid application position B1 instructed by the binding command. The controller 100b executes the operation of step S701 before a first sheet P is conveyed to the internal tray 22 by the conveyance roller pairs 10, 11, 14, and 15.

In step S702, the controller 100b rotates the conveyance roller pairs 10, 11, 14, and 15 to store the sheet P, on which the image has been formed by the image forming apparatus 2, onto the internal tray 22. In step S702, the controller 100b also moves the side fences 24L and 24R to align the position of the sheet P or the sheet bundle Pb placed on the internal tray 22 in the main scanning direction. In short, the controller 100b performs so-called jogging.

In step S703, the controller 100b causes the liquid applier 31 facing the liquid application position B1 to apply liquid to the liquid application position B1 of the sheet P placed on the internal tray 22 in the immediately preceding step S702, based on the liquid application control data adjusted in advance. In other words, the controller 100b drives the liquid-applier movement motor 42 to bring the liquid application member 501 into contact with the liquid application position B1 on the sheet P placed on the internal tray 22 (see FIG. 13B). In the liquid application process in step S703, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid-applier movement motor 42 based on the adjusted control data, and adjusts the amount of movement of the liquid application member 501 with respect to the liquid application position B1 of the sheet P placed on the internal tray 22.

In step S704, the controller 100b determines whether the number of sheets P placed on the internal tray 22 has reached the given number N instructed by the binding command. When the controller 100b determines that the number of sheets P placed on the internal tray 22 has not reached the given number of sheets N (NO in step S704), the controller 100b executes the operations of steps S702 to S704 again until the number of sheets P placed on the internal tray 22 reaches the given number of sheets N (YES in step S704). In other words, the controller 100b executes the processing of steps S702 to S704 each time the sheet P is conveyed to the internal tray 22 by the conveyance roller pairs 10, 11, 14, and 15. The liquid application by the liquid applier 31 may be performed on each of the sheets P of the sheet bundle Pb.

When the controller 100b determines that the number of sheets P placed on the internal tray 22 has reached the given number of sheets N (YES in step S704), in step S705, the controller 100b drives the edge-binder movement motor 55 to move the edge binder 25 in the main scanning direction such that the crimper 32 faces the first binding position B1 as illustrated in FIG. 13C.

In step S706, the controller 100b causes the crimper 32 to crimp the sheet bundle Pb placed on the internal tray 22. In step S707, the controller 100b causes the conveyance roller pair 15 to eject the sheet bundle Pb thus crimped and bound by the crimper 32 to the ejection tray 26. Specifically, the controller 100b drives the contact-separation motor 32d to cause the upper crimping teeth 32a and the lower crimping teeth 32b to pinch the binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the ejection tray 26.

The sheet bundle Pb placed on the internal tray 22 has a crimping area (corresponding to the binding position B1) pinched between the upper crimping teeth 32a and the lower crimping teeth 32b in step S706. The crimping area overlaps a liquid application area (corresponding to the liquid application position B1) contacted by a distal end (tip portion) of the liquid application member 501 in step S703. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlap with the liquid application area contacted by the distal end of the liquid application member 501, to obtain a sufficient binding strength.

In step S708, the controller 100b determines whether the number of sheet bundles Pb thus ejected to the ejection tray 26 has reached the requested number of copies M indicated by the binding command. When the controller 100b determines that the number of sheet bundles Pb thus ejected has not reached the requested number of copies M (NO in step S708), the controller 100b executes the operations of step S702 and its subsequent steps again. In other words, when the controller 100b determines that the number of sheet bundles Pb thus ejected has not reached the requested number of copies M (NO in step S708), the controller 100b repeats the operations of steps S702 to S708 until the number of sheet bundles Pb ejected to the ejection tray 26 reaches the requested number of copies M.

On the other hand, when the controller 100b determines that the number of sheet bundles Pb output to the ejection tray 26 has reached the requested number of copies M (YES in step S708), in step S709, the controller 100b drives the edge-binder movement motor 55 to move the edge binder 25 (the liquid applier 31 and the crimper 32) to the standby position HP as illustrated in FIG. 13A. When the posture that is instructed by the binding command is the “oblique binding posture,” in step S709, the controller 100b drives the liquid-applier pivot motor 563 and the crimper pivot motor 56 to rotate the liquid applier 31 and the crimper 32 into the parallel binding posture. On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 13A. In steps S701 and S709, the execution order of the movement in the main scanning direction and the rotation in the forward and reverse directions of the liquid applier 31 and the crimper 32 is not limited to the aforementioned order and may be reversed.

A detailed description is given below of a second liquid storage tank 47.

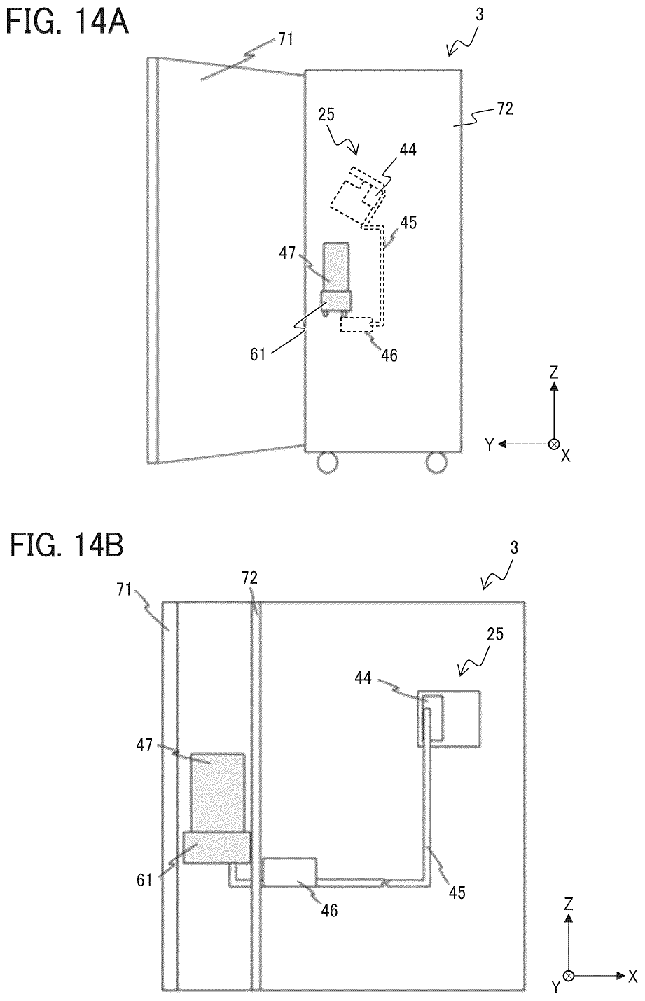

Referring now to FIGS. 14A, 14B, and 15, a description is given of the arrangement and configuration of the second liquid storage tank 47 in the post-processing apparatus 3. FIGS. 14A and 14B illustrate an example of the location and configuration of the second liquid storage tank 47 as a main tank. FIG. 14A illustrates the post-processing apparatus 3 with a cover 71 opened. FIG. 14B is a cross-sectional side view of the post-processing apparatus 3, illustrating the post-processing apparatus 3 with the cover 71 closed. As illustrated in FIGS. 14A and 14B, the second liquid storage tank 47 is located so as to be accessible when the cover 71 of the post-processing apparatus 3 is opened. As illustrated in FIG. 14B, the second liquid storage tank 47 and the second-liquid-storage-tank fixer 61 are disposed on the near side in a depth direction (X direction) of the post-processing apparatus 3. The first liquid storage tank 44 is disposed on the far side in the depth direction (X direction) of the post-processing apparatus 3. A housing side plate 72 of the post-processing apparatus 3 is disposed between the arrangement position of the second liquid storage tank 47 and the second-liquid-storage-tank fixer 61 and the arrangement position of the first liquid storage tank 44. The second-liquid-storage-tank fixer 61 is attached to the housing side plate 72 of the post-processing apparatus 3.

FIG. 15 illustrates the second liquid storage tank 47 attachable to and detachable from the second-liquid-storage-tank fixer 61 and a state where liquid is replenished to the second liquid storage tank 47. As illustrated in part (A) of FIG. 15, the second liquid storage tank 47 is detachably attached to the first liquid storage tank 44 so that the second liquid storage tank 47 can replenish the liquid to the first liquid storage tank 44. As illustrated in part (B) of FIG. 15, the second-liquid-storage-tank fixer 61 is provided with the setting detection sensor 51 as an example of a setting detector that detects that the second liquid storage tank 47 is set in the second-liquid-storage-tank fixer 61.

When the setting detection sensor 51 detects the set state of the second liquid storage tank 47 to the second-liquid-storage-tank fixer 61 (see part (C) of FIG. 15), a signal indicating the set state is transmitted to the controller 100b. Thus, the controller 100b detects whether the second liquid storage tank 47 is set on the second-liquid-storage-tank fixer 61.

The second liquid-level sensor 52 (an example of a second liquid detector) that detects the amount of liquid L to be stored in the second liquid storage tank 47 is disposed in the second-liquid-storage-tank fixer 61. The output value (voltage) of the second liquid-level sensor 52 is notified to the controller 100b. The controller 100b determines the output value (voltage) of the second liquid-level sensor 52 to determine whether the amount of liquid stored in the second-liquid-storage-tank fixer 61 is a required amount of liquid. When the controller 100b determines that the second liquid storage tank 47 is in the mount state based on the output signal of the setting detection sensor 51, the controller 100b turns on the second liquid-level sensor 52 such that the remaining amount of liquid (the amount of the liquid stored) in the second-liquid-storage-tank fixer 61 can be detected.

When the second liquid storage tank 47 is not set on the second-liquid-storage-tank fixer 61 (i.e., is in a non-set state), an outlet of the second liquid storage tank 47 is closed by a liquid supply valve 471 so that the liquid does not leak. As illustrated in part (C) of FIG. 15, when the second liquid storage tank 47 is set to the second-liquid-storage-tank fixer 61, the liquid supply valve 471 is pushed up to open a liquid discharge port 471a of the second liquid storage tank 47. Thus, the liquid flows out from the second liquid storage tank 47 to the second-liquid-storage-tank fixer 61. As a result, the liquid stored in the second liquid storage tank 47 flows out to the second-liquid-storage-tank fixer 61. The liquid flown from the second liquid storage tank 47 is temporarily stored in the second-liquid-storage-tank fixer 61.

As a measurement to prevent the liquid from being frozen during maintenance of the post-processing apparatus 3, a liquid draining process may be performed to drain the liquid in the post-processing apparatus 3. In the liquid draining process, the liquid remaining in the first liquid storage tank 44 and the liquid supply passage 45 is supplied by the liquid supply pump 46 to the second-liquid-storage-tank fixer 61 via the liquid supply passage 45 in the reverse direction. In order to deal with such a situation, the second-liquid-storage-tank fixer 61 is set to the amount to sufficiently store liquid in the first liquid storage tank 44 and the liquid supply passage 45. The second-liquid-storage-tank fixer 61 has a liquid drain plug 611. After the liquid remaining in the first liquid storage tank 44 and the liquid supply passage 45 is reversely fed by the liquid supply pump 46 to the second-liquid-storage-tank fixer 61, the liquid drain plug 611 is opened to discharge the liquid stored in the second-liquid-storage-tank fixer 61 from the inside of the post-processing apparatus 3.

A description is given of a configuration of liquid application according to the first embodiment.

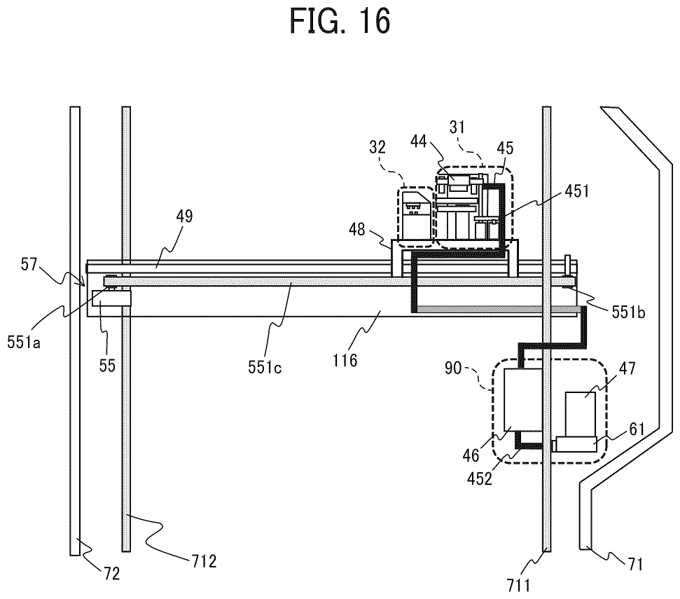

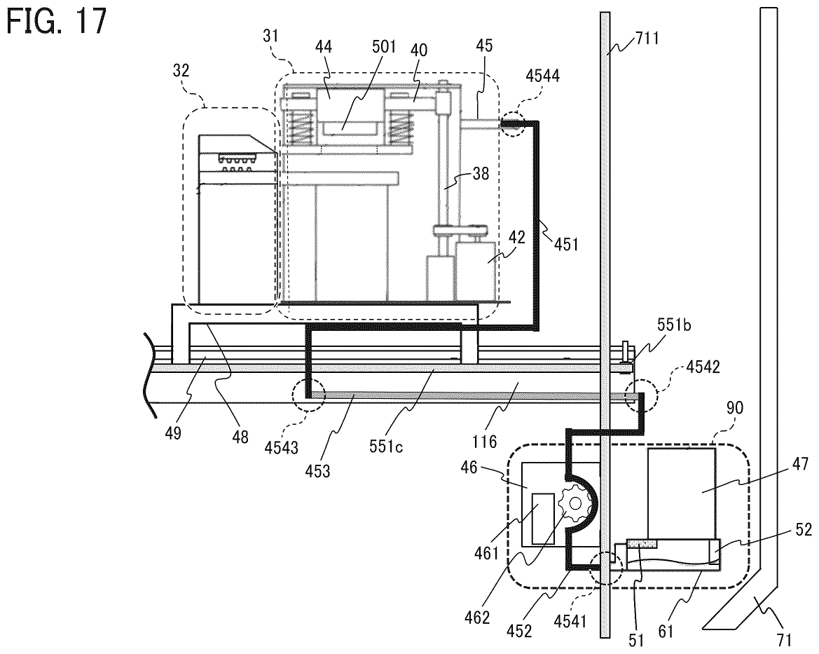

More specifically, a description is given of an overview of the configuration used for liquid application in the edge binder 25 and the staple binder 155 included in the post-processing apparatus 3 and the configuration of supplying liquid to the edge binder 25 and the staple binder 155. FIGS. 16 and 17 are views including the structure around the edge binder 25 described with reference to FIG. 3.

As described above, the liquid applier 31 is arranged side by side with the crimper 32. The second liquid applier 612 is also arranged side by side with the stapler 62. The liquid appliers arranged side by side with the respective binders are movable in the width direction of the sheet P by the edge-binder movement assembly 57 when the liquid application is performed on the sheet P for the binding process. In other words, the direction in which the binder and the liquid applier move relative to the sheet P in the liquid application process is the width direction of the sheet P. In other words, the direction of movement of the liquid applier arranged side by side with the binder is a direction orthogonal to the conveyance direction of the sheet P. This direction is referred to as a reciprocating direction.

More specifically, as described above, the crimper 32 and the liquid applier 31 are attached to the base 48. The crimper 32 and the liquid applier 31 are movable in the main scanning direction along the guide shaft 49 by the edge-binder movement motor 55 and a driving force transmission assembly 551 (including pulleys 551a and 551b and timing belt 551c) that transmits the driving force of the edge-binder movement motor 55 to the base 48. The direction along the guide shaft 49 (main scanning direction) corresponds to the reciprocating direction according to the present embodiment.

The guide shaft 49 is disposed on a binding assembly base 116 by multiple guide shaft brackets 49a. The binding assembly base 116 is a member disposed so as to bridge between a housing front side plate 711 and a housing rear side plate 712 of the post-processing apparatus 3. The guide shaft 49 supports the liquid applier 31 and the crimper 32 to be movable in a reciprocating manner within a range in which the guide shaft 49 is fixed to the binding assembly base 116.

The liquid applier 31 includes the first liquid storage tank 44 for storing the liquid for the liquid application process. The first liquid storage tank 44 is disposed near the liquid application member 501. Further, for example, a liquid replenishment unit 90 is disposed on the housing front side plate 711. Opening the cover 71 of the post-processing apparatus 3 causes the user to be accessible to the second liquid storage tank 47 included in the liquid replenishment unit 90, so that the second liquid storage tank 47 can be detached from the liquid replenishment unit 90 for replenishing (supplying) liquid. After the liquid is replenished to the second liquid storage tank 47, the second liquid storage tank 47 is set to the second-liquid-storage-tank fixer 61. By so doing, the second liquid storage tank 47 is filled with a certain amount of liquid in the second-liquid-storage-tank fixer 61. The second-liquid-storage-tank fixer 61 includes the second liquid-level sensor 52 (see FIG. 17) that detects the liquid level when the liquid is equal to or smaller than the set amount.

FIG. 17 is an enlarged diagram illustrating the configuration and operation of the edge binder 25 and the area around the edge binder 25. As illustrated in FIG. 17, the liquid replenishment unit 90 fixed to the housing front side plate 711 includes the liquid supply pump 46. The liquid supply pump 46 is fixed to the housing front side plate 711.

The liquid supply pump 46 is a tube-type constant-amount liquid feeding pump having a configuration in which, as a pump motor 461 rotates, a shoe 462 contacting a second silicon tube 452 as a part of the liquid supply passage 45 rotates. The position at which the shoe 462 compresses the second silicon tube 452 is sequentially moved, and thus the liquid stored in the second-liquid-storage-tank fixer 61 feeds air or liquid flowing into the liquid supply passage 45 (the second silicon tube 452) in the rotational direction of the shoe 462.

Since the rotational amount of the shoe 462 and the amount of liquid to be fed are constant in the tube-type constant-amount liquid feeding pump, the tube-type constant-amount liquid feeding pump can feed the constant amount of liquid and no valve structure is needed. In the present embodiment, the liquid supply pump 46 employs a tube-type constant-amount liquid feeding pump. However, the configuration of a tube-type constant-amount liquid feeding pump is not limited to the above-described pump and any liquid feeding pump may be applied as long as liquid can be fed. For example, a propeller pump, a screw pump, or a peristaltic pump may be used.

A detailed description is given of the configuration of the liquid supply passage 45. The liquid supply passage 45 includes a first silicon tube 451, an elastic tube 453, a second silicon tube 452, and two or more supply coupling portions 454, in other words, multiple supply coupling portions 454. The first silicon tube 451 is a cylindrical tube having a hollow cylindrical cross section. The elastic tube 453 has a hollow cylindrical cross section and includes an elastic member serving as an extendable member. The second silicon tube 452 is a cylindrical tube having a hollow cylindrical cross section. The two or more (multiple) supply coupling portions 454 couple the first silicon tube 451, the second silicon tube 452, and the elastic tube 453 to the liquid replenishment unit 90 or the liquid applier 31.

In the present embodiment, the liquid supply passage 45 is illustrated as a liquid supply passage including a tube and a joint to supply liquid from the second liquid storage tank 47 to the first liquid storage tank 44. However, the configuration of the liquid supply passage 45 is not limited to the above-described configuration, and any configuration may be applied to a liquid supply passage as long as the configuration can perform the function as a liquid supply passage. For example, as long as the liquid can be fed without leaking, the material and the connection method are not limited, and a connection method incorporated in each component may be used.

The second-liquid-storage-tank fixer 61 and the second silicon tube 452 are coupled to each other by a first supply coupling portion 4541 so that the second silicon tube 452 passes through the liquid supply pump 46.

The elastic tube 453 is coupled, by the second supply coupling portion 4542, to the second silicon tube 452 that is coupled to the outlet portion of the liquid supply pump 46. The elastic tube 453 enters from the opening of the binding assembly base 116 to be disposed along the movement direction of the liquid applier 31.

The elastic tube 453 is coupled to the first silicon tube 451 by a third supply coupling portion 4543 and to the second silicon tube 452 by the second supply coupling portion 4542. The elastic tube 453 is disposed so as to be expandable and contractable in the reciprocating direction of the liquid applier 31 with ends of the elastic tube 453 being fixed to the third supply coupling portion 4543 and the second supply coupling portion 4542.

The first silicon tube 451 passes through, for example, the lower side of the base 48 and is coupled to the first liquid storage tank 44 by a fourth supply coupling portion 4544 from the liquid applier 31 on the front side of the post-processing apparatus 3. The liquid can be fed to the first liquid storage tank 44 by feeding out the air or the liquid along the liquid supply passage from the second liquid storage tank 47 to the first liquid storage tank 44.

A description is given of a configuration of liquid supply according to a second embodiment.

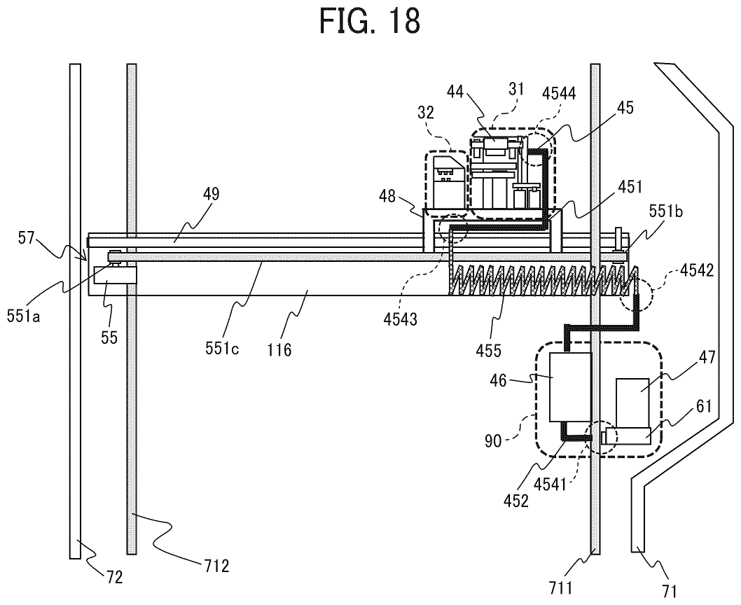

More specifically, a description is given of an overview of the configuration used for liquid application in the edge binder 25 and the staple binder 155 included in the post-processing apparatus 3 and the configuration of supplying liquid to the edge binder 25 and the staple binder 155. FIG. 18 is a diagram illustrating yet another operation performed by a liquid applier according to the present embodiment. The configuration of the second embodiment illustrated in FIG. 18 is different in an elastic liquid supply member from the configuration of the first embodiment described above. In other words, FIG. 18 illustrates the configuration of the second embodiment that employs a coil tube 455 including an elastic member wound in a spiral, as an extendable member, instead of the member in the portion where the elastic tube 453 is used in the first embodiment.

As described above, the liquid supply passage 45 includes a liquid supply passage that couples the first liquid storage tank 44 and the second liquid storage tank 47. In the present embodiment, the liquid supply passage 45 serving as a liquid supply passage includes the coil tube 455, the liquid supply pump 46, the first silicon tube 451 serving as a cylindrical tube having a hollow cylindrical cross section, and the second silicon tube 452 serving as a cylindrical tube having a hollow cylindrical cross section.

The first silicon tube 451 has one end that is coupled to the first liquid storage tank 44 by the fourth supply coupling portion 4544 and the other end that is coupled to the coil tube 455 by the third supply coupling portion 4543. The second silicon tube 452 has one end that is coupled to a coil tube 455 by a second supply coupling portion 4542 and the other end that is coupled to an outlet portion of the second liquid storage tank 47 by the first supply coupling portion 4541. The second silicon tube 452 includes the liquid supply pump 46.

As the liquid supply pump 46 is driven, the liquid stored in the second liquid storage tank 47 is supplied (replenished) to the coil tube 455 via the second silicon tube 452. The liquid fed to the coil tube 455 runs in the coil tube 455. Then, the liquid further runs in the first silicon tube 451 to be fed to the first liquid storage tank 44. When the crimper 32 and the liquid applier 31 reciprocate along the guide shaft 49, the spring-shape portion of the coil tube 455 extends or contracts, so that the liquid supply passage 45 can be followed in the reciprocating motion.

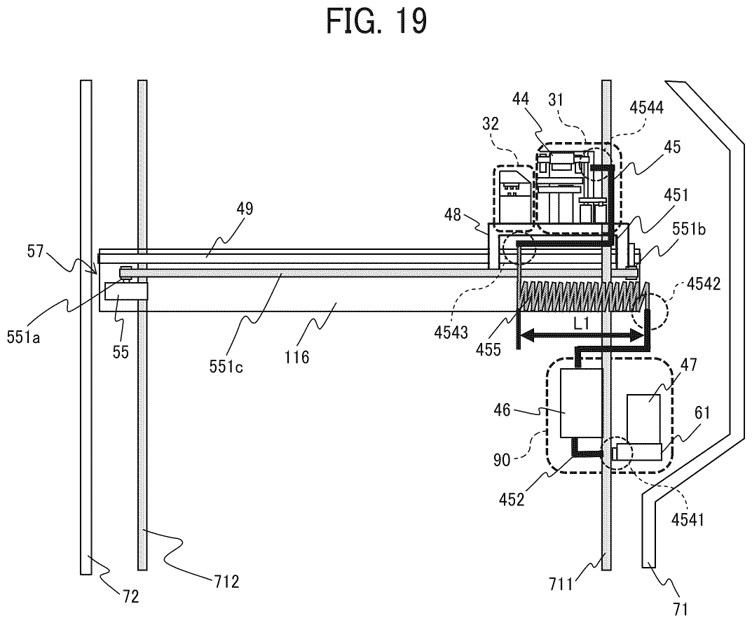

A description is given below of the liquid supplying configuration including the coil tube 455, with reference to FIG. 19. FIG. 19 is a diagram illustrating the liquid supplying configuration in a case where the crimper 32 and the liquid applier 31 are moved to the nearest side to the post-processing apparatus 3. The “case where the crimper 32 and the liquid applier 31 are moved to the nearest side to the post-processing apparatus 3” is a case where, for example, the liquid applier 31 is moved to one end of the movement limit in a depth direction of the post-processing apparatus 3, in other words, a case where the liquid applier 31 is moved to the closest position to the cover 71 of the post-processing apparatus 3.

In this case, the movement of the liquid applier 31 moves the first silicon tube 451, which is coupled to the liquid applier 31 by the fourth supply coupling portion 4544, and the coil tube 455, which is coupled to the first silicon tube 451 by the third supply coupling portion 4543, in the same direction as the direction of movement of the liquid applier 31 to follow the liquid applier 31. As a result, as illustrated in FIG. 19, the coil tube 455 disposed along the guide shaft 49 is contracted in the axial direction of the guide shaft 49. The entire length of the coil tube 455 in this contracted state is referred to as a “first coil length L1”.

In the present embodiment, the range of movement of the liquid applier 31 is limited so that the first coil length L1 is longer than the natural length of the coil tube 455 (the length of the coil tube 455 when the coil tube 455 is not contracted or expanded). By this limitation, even when the liquid applier 31 moves in the width direction, the liquid supply passage 45 serving as a liquid supply passage including the coil tube 455 can be prevented from bending, and can be prevented from blocking the supply of liquid.

In the liquid supply passage including the coil tube 455 or in the state where the post-processing apparatus 3 is not used, it is desirable that the standby position of the liquid applier 31 illustrated in FIG. 16 is located at the position of the liquid applier 31. In other words, when the liquid application process is not executed, the liquid applier 31 is desirably at a position closer to the liquid replenishment unit 90 (the cover 71 of the post-processing apparatus 3) in the direction of the guide shaft 49 than the intermediate position in the depth direction of the post-processing apparatus 3. As described above, the liquid applier 31 stands by a specified position when the liquid applier 31 does not move. Thus, the external force applied to the coil tube 455 can be reduced.

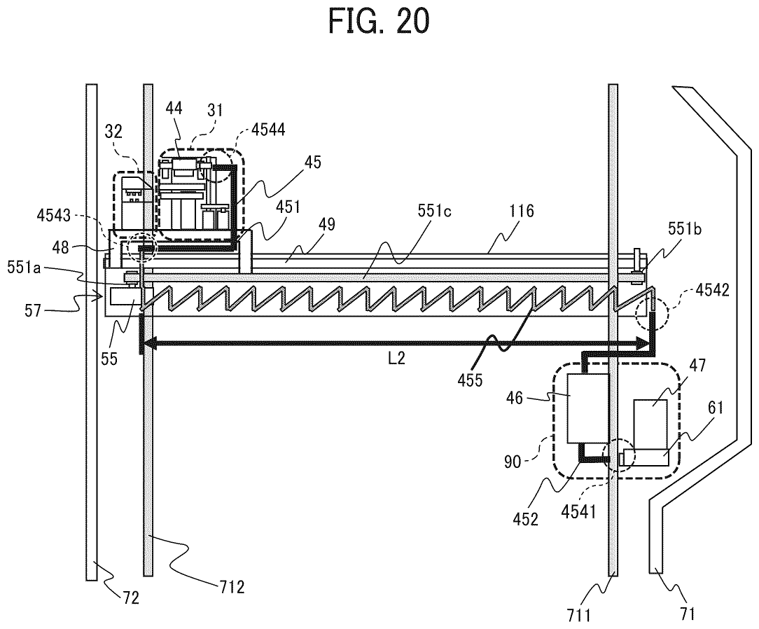

A description is given below of the liquid supplying configuration including the coil tube 455, with reference to FIG. 20. FIG. 20 is a diagram illustrating the liquid supplying configuration in a case where the crimper 32 and the liquid applier 31 are moved to the farthest side of the post-processing apparatus 3. The “case where the crimper 32 and the liquid applier 31 are moved to the farthest side of the post-processing apparatus 3” is a case where, for example, the liquid applier 31 is moved to the other end of the movement limit in the depth direction of the post-processing apparatus 3, in other words, a case where the liquid applier 31 is moved to the position at which the liquid applier 31 can get closest to the housing side plate 72 of the post-processing apparatus 3.

In this case, the movement of the liquid applier 31 moves the first silicon tube 451, which is coupled to the liquid applier 31 by the fourth supply coupling portion 4544, and the coil tube 455, which is coupled to the first silicon tube 451 by the third supply coupling portion 4543, in the same direction as the direction of movement of the liquid applier 31 to follow the liquid applier 31. As a result, as illustrated in FIG. 20, the coil tube 455 disposed along the guide shaft 49 is extended in the axial direction of the guide shaft 49. The entire length of the coil tube 455 in this extended state is referred to as a “second coil length L2.”

In the present embodiment, the range of movement of the liquid applier 31 is limited so that the second coil length L2 is two times or more the first coil length L1 (the natural length of the coil tube 455) and the coil tube 455 is not plastically deformed. In other words, the range in which the length of the coil tube 455 changes in accordance with the movement of the liquid applier 31 is set to fall between the first coil length L1 that is longer than the natural length of the coil tube 455 and the second coil length L2 that is two times or more the first coil length L1.

Further, the liquid supply passage can be shortened by minimizing the number of turns of the coil tube 455 with the condition of the second coil length L2 (two times or more the first coil length L1) being satisfied. By so doing, the time for supplying liquid can be shortened and the amount of liquid to be replenished can be reduced.

A description is given of a configuration of liquid supply according to a third embodiment.

More specifically, a description is given of an overview of the configuration used for liquid application in the edge binder 25 included in the post-processing apparatus 3 and the configuration of supplying liquid to the edge binder 25, according to the third embodiment. Note that present embodiment can be combined with another embodiment without departing from the spirit of the present disclosure. In the following, detailed description of the common points with other embodiments will be omitted, and the configuration unique to the present embodiment will be mainly described.

The post-processing apparatus 3 according to the third embodiment includes at least the edge binder 25 (e.g., the liquid applier 31 as an example of a liquid applier and the crimper 32 as an example of a post-processing device or a crimping device), the edge-binder movement assembly 57 (as an example of a movement assembly), the first liquid storage tank 44 (as an example of a first liquid storage), the second liquid storage tank 47 (as an example of a second liquid storage), the coil tube 456 (as an example of a liquid supply passage), the controller 100b, and the operation panel 110 (which is an example of a notifier or an operation device). The post-processing apparatus 3 according to the third embodiment can include some or all of the components described in the other embodiments.

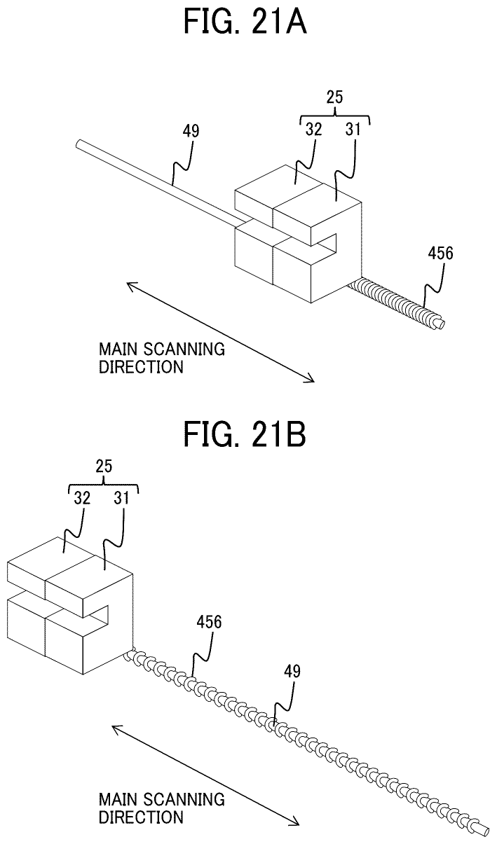

FIGS. 21A and 21B are perspective views of the edge binder 25 and the coil tube 456 according to the third embodiment. As illustrated in FIGS. 21A and 21B, the edge binder 25 is supported by a guide shaft 49 extending in the main scanning direction (i.e., the width direction of the sheet P supported by the internal tray 22). The edge binder 25 can be moved in one direction and the other direction along the main scanning direction by a driving force of the edge-binder movement assembly 57.

The coil tube 456 connects the second liquid storage tank 47 and the first liquid storage tank 44. The coil tube 456 supplies the liquid stored in the second liquid storage tank 47 to the first liquid storage tank 44. More specifically, the coil tube 456 connects the first liquid storage tank 44 that is mounted on the liquid applier 31 for movement and the second liquid storage tank 47 that is fixed to a predetermined position outside the liquid applier 31.

Therefore, the coil tube 456 has flexibility to expand and contract in accordance with the movement of the liquid applier 31 (i.e., the edge binder 25). The coil tube 456 according to the third embodiment extends in a spiral shape. The coil tube 456 is wound around the guide shaft 49. As illustrated in FIGS. 21A and 21B, the coil tube 456 expands and contracts along the guide shaft 49 as the liquid applier 31 moves in the main scanning direction. The expansion and contraction of the coil tube 456 means that the interval (i.e., pitch) of the spiral increases and decreases. However, the liquid supply passage is not limited to the form of the coil tube 456 as long as the liquid supply passage is expandable and contractible.

The edge-binder movement motor 55 (driving source) included in the edge-binder movement assembly 57 is, for example, a direct current (DC) motor. The controller 100b supplies a driving current (direct current) to the edge-binder movement motor 55 to rotate the edge-binder movement motor 55 (i.e., move the edge binder 25). However, the edge-binder movement motor 55 is not limited to the DC motor, and may be, for example, a servo motor or a stepping motor as long as a driving signal (e.g., a current value, a voltage value, or a pulse waveform) varies according to a load as described later.

The controller 100b increases or decreases the driving current in accordance with the load of the edge-binder movement motor 55 by, for example, feedback control. In other words, the controller 100b increases the driving current as the load of the edge-binder movement motor 55 increases, and decreases the driving current as the load of the edge-binder movement motor 55 decreases. More specifically, the controller 100b adjusts the driving current so that the edge-binder movement motor 55 has a target number of rotations per unit time. In other words, the controller 100b increases the driving current when the actual number of rotations per unit time of the edge-binder movement motor 55 is smaller than the target number of rotations per unit time, and decreases the driving current when the actual number of rotations per unit time is greater than the target number of rotations per unit time. Since the process of increasing or decreasing the driving current in accordance with the load is already known, a detailed description thereof will be omitted.

When the post-processing apparatus 3 is used in a cold region, the liquid in the coil tube 456 may freeze. The cold region refers to, for example, an environment in which the temperature is below the freezing point (below the freezing point of liquid) even indoors. The liquid frozen in the coil tube 456 resists the movement of the liquid applier 31 (i.e., the edge binder 25). In other words, if the liquid in the coil tube 456 is frozen, the load of the edge-binder movement motor 55 for moving the liquid applier 31 (i.e., the edge binder 25) increases compared to a case where the liquid in the coil tube 456 is not frozen.

A description is given below of screens displayed on the operation panel 110.

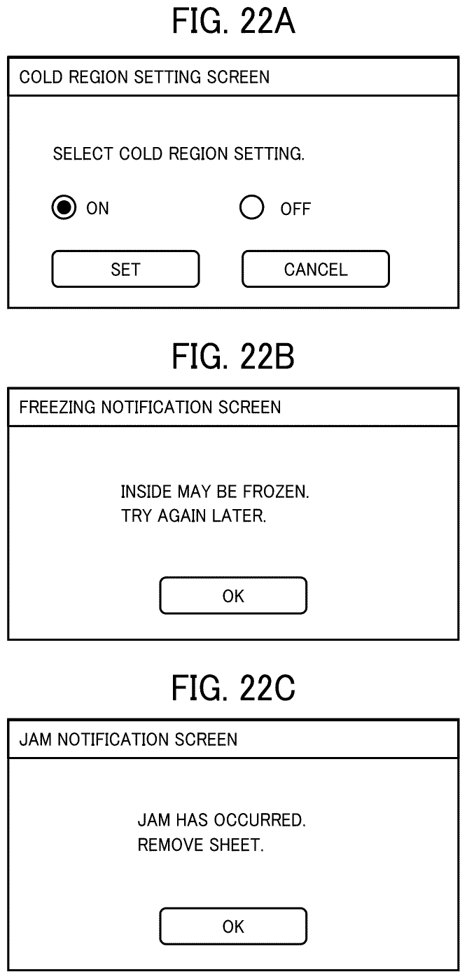

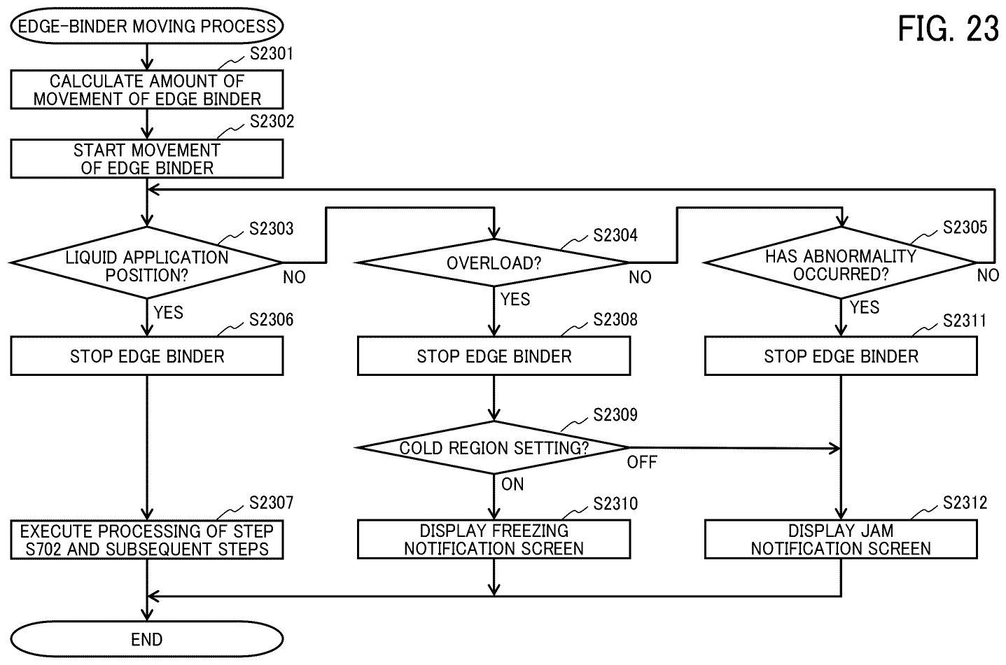

FIG. 22A is a diagram illustrating an example of the appearance of a cold region setting screen. FIG. 22B is a diagram illustrating an example of the appearance of a freezing notification screen. FIG. 22C is a diagram illustrating an example of the appearance of a jam notification screen. Each of the screens illustrated in FIGS. 22A to 22C is displayed on the display of the operation panel 110. More specifically, the controller 100b displays the cold region setting screen in accordance with the operation of the user through the operation panel 110. Further, the controller 100b causes the freezing notification screen to be displayed in step S2310 of FIG. 23, and causes the jam notification screen to be displayed in step S2312.

The cold region setting screen illustrated in FIG. 22A is a screen for allowing the user to set whether the post-processing apparatus 3 (i.e., the image forming system 1) is used in a cold region. The cold region setting screen displays, for example, a message “Select cold region setting.”, a radio button “ON” indicating use of the post-processing apparatus 3 in a cold region, a radio button “OFF” indicating use of the post-processing apparatus 3 in a region other than a cold region, a “set” icon, and a “cancel” icon. When the controller 100b receives an operation of the user who selects one of the radio buttons and taps the “set” icon through the operation panel 110, the controller 100b stores the cold region setting (ON or OFF) in the HDD 104. The initial value of the cold region setting (the value before setting through the cold region setting screen) is, for example, OFF.

The freezing notification screen illustrated in FIG. 22B is a screen for notifying the user that the liquid inside the post-processing apparatus 3 (more specifically, inside the coil tube 456) is frozen. The jam notification screen illustrated in FIG. 22C is a screen for notifying the user that the sheet P is jammed inside the post-processing apparatus 3 (which is referred to as “jam” in the following description). The jam is an example of an abnormality of the post-processing apparatus 3. However, the abnormality of the post-processing apparatus 3 is not limited to jam, and corresponds to any state in which the post-processing apparatus 3 cannot continue the post-processing.

A description is given below of an edge-binder moving process.

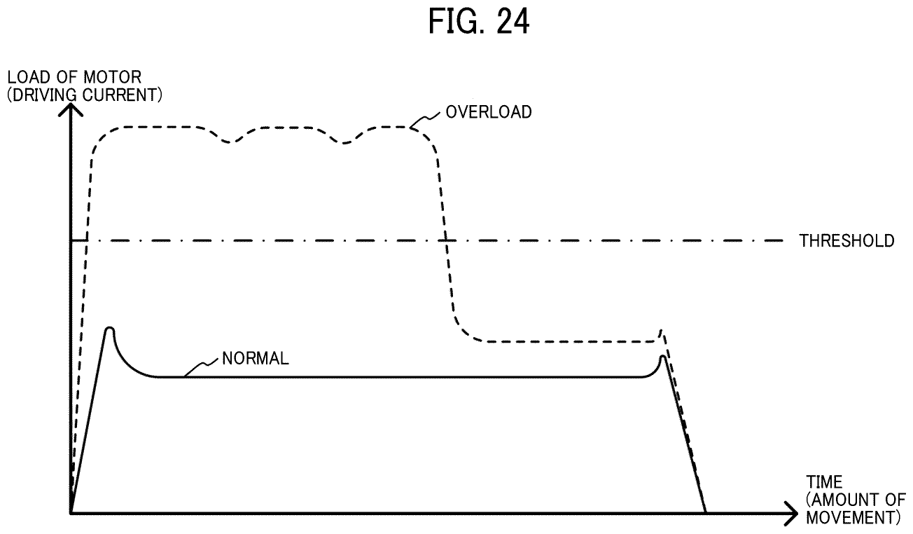

FIG. 23 is a flowchart of the edge-binder moving process. FIG. 24 is a graph illustrating an example of a change over time in the load (magnitude of th driving current) of the edge-binder movement motor 55 in the edge-binder moving process. The controller 100b executes the edge-binder moving process in, for example, step S701 of FIG. 12. However, the description of the posture change of the liquid applier 31 in the edge-binder moving process will be omitted below.

In step S2301, the controller 100b calculates the amount of movement in the main scanning direction from the current position (e.g., the standby position HP) of the edge binder 25 (e.g., the liquid applier 31) to the liquid application position B1. In step S2302, the controller 100b starts the movement of the edge binder 25 to the liquid application position B1 by rotating the edge-binder movement motor 55. The controller 100b continues the rotation of the edge-binder movement motor 55 until the liquid applier 31 faces the liquid application position B1 (step S2303), the edge-binder movement motor 55 is overloaded (step S2304), or another abnormality (e.g., jam) occurs in the post-processing apparatus 3 (step S2305).

The controller 100b increases or decreases the driving current in accordance with the load of the edge-binder movement motor 55 by feedback control. As illustrated in FIG. 24, the driving current supplied to the edge-binder movement motor 55 by the controller 100b gradually increases from the start of the movement of the edge binder 25 to reach a peak, and gradually decreases after a steady section. When the liquid in the coil tube 456 is frozen (at the time of overload indicated by the broken line), the maximum value of the driving current is greater than that when the liquid is not frozen (at the time of normal operation indicated by the solid line). Then, the controller 100b stores a value greater than the peak at the time of normal operation and smaller than the peak at the time of overload in the HDD104 as a threshold. The threshold is determined in advance by, for example, an experiment or a simulation.

In response to the liquid applier 31 facing the liquid application position B1 (YES in step S2303), in step S2306, the controller 100b stops the edge binder 25 (i.e., stops the supply of the driving current to the edge-binder movement motor 55), and executes the processing of step S702 and its subsequent steps in FIG. 12.

Further, when the load (driving current) of the edge-binder movement motor 55 exceeds the threshold before the liquid applier 31 faces the liquid application position B1 (NO in step S2303 and YES in step S2304), the controller 100b stops the edge binder 25 in step S2308. In step S2309, the controller 100b determines the value of the cold region setting stored in the HDD104. When the cold region setting is ON (ON in step S2309), the controller 100b causes the freezing notification screen illustrated in FIG. 22B to be displayed on the operation panel 110 in step S2310. On the other hand, when the cold region setting is OFF (OFF in step S2309), the controller 100b causes the operation panel 110 to display a screen for notifying an abnormality of the post-processing apparatus 3 (e.g., the freezing notification screen illustrated in FIG. 22B) in step S2312.

Further, when an abnormality (e.g., jam) occurs in the post-processing apparatus 3 before the liquid applier 31 faces the liquid application position B1 (NO in step S2303 and YES in step S2305, the controller 100b stops the edge binder 25 in step S2311 and displays the jam notification screen illustrated in FIG. 22C on the operation panel 110 in step S2312. When the controller 100b executes steps S2310 and S2312, the controller S702 may execute the processing of step S702 and its subsequent steps in FIG. 12 after the abnormality (overload or jam) is solved, or may end the binding process without executing the processing of step S702 and its subsequent steps.

A description is given below of an operation and effect of the third embodiment.

According to the third embodiment, the state of the liquid (presence or absence of freezing) in the coil tube 456 is detected by the magnitude of the load (driving current) of the edge-binder movement motor 55, thus allowing the edge binder 25 to be stopped. This can prevent damage to the post-processing apparatus due to forcible movement of the edge binder 25 in a state where the liquid is frozen. Further, since it is not necessary to newly add a thermistor or a heater, the above-described operation and effect can be obtained with a simple configuration.

According to the third embodiment, the freezing notification screen is displayed when the overload is detected, and thus the user can recognize the state of the post-processing apparatus 3. However, the overload of the edge-binder movement motor 55 is not limited to the case where the liquid is frozen, and it is also considered that the edge binder 25 cannot be moved due to the obstruction of the sheet P jammed on the internal tray 22. Therefore, the cold region setting is set in advance by the user, thus preventing the freezing notification screen from being displayed on the post-processing apparatus 3 used in an environment where there is no possibility of freezing.

The controller 100b may receive an input of a time zone (e.g., 4 a.m. to 8 a.m.) in which the liquid is likely to freeze from the user through the operation panel 110 in addition to the cold region setting. The controller 100b may display the freezing notification screen when the time at which the overload is detected is within the time zone, and may display the jam notification screen when the time at which the overload is detected is out of the time zone.

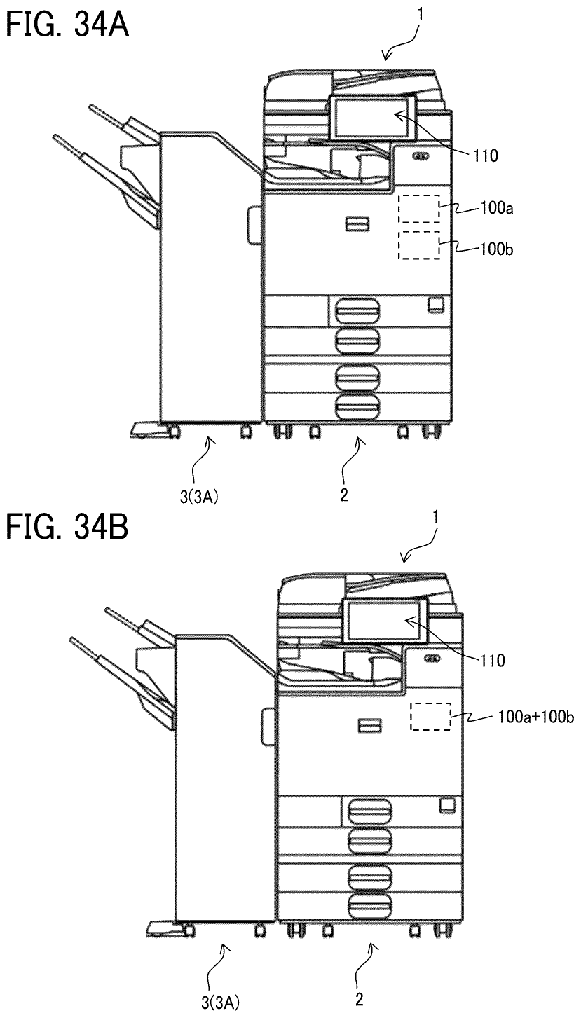

In the above description, the controller 100b of the post-processing apparatus 3 is provided separately from the controller 100a of the image forming apparatus 2 as illustrated in FIG. 1. However, the present disclosure is not limited to the above-described configuration. For example, as illustrated in FIG. 34A, the controller 100b of the post-processing apparatus 3 may be disposed in the image forming apparatus 2. Further, as illustrated in FIG. 34B, the controller 100b of the post-processing apparatus 3 may be integrated with the controller 100a of the image forming apparatus 2.

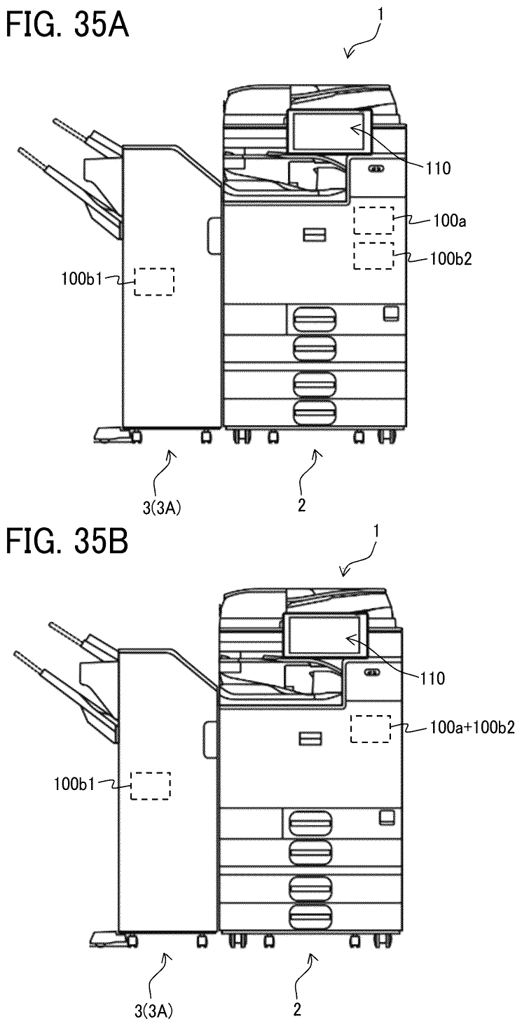

As illustrated in FIG. 35A, the controller 100b of the post-processing apparatus 3 may be divided into a controller 100b1 (e.g., a drive unit such as a motor) and a controller 100b2 (a detector such as a sensor) according to the function, and the controller 100b2 of the post-processing apparatus 3 may be disposed in the image forming apparatus 2. Further, as illustrated in FIG. 35B, the controller 100b2 of the post-processing apparatus 3 disposed in the image forming apparatus 2 may be integrated with the controller 100a of the image forming apparatus 2.

A description is given below of a post-processing apparatus 3A according to a second embodiment.

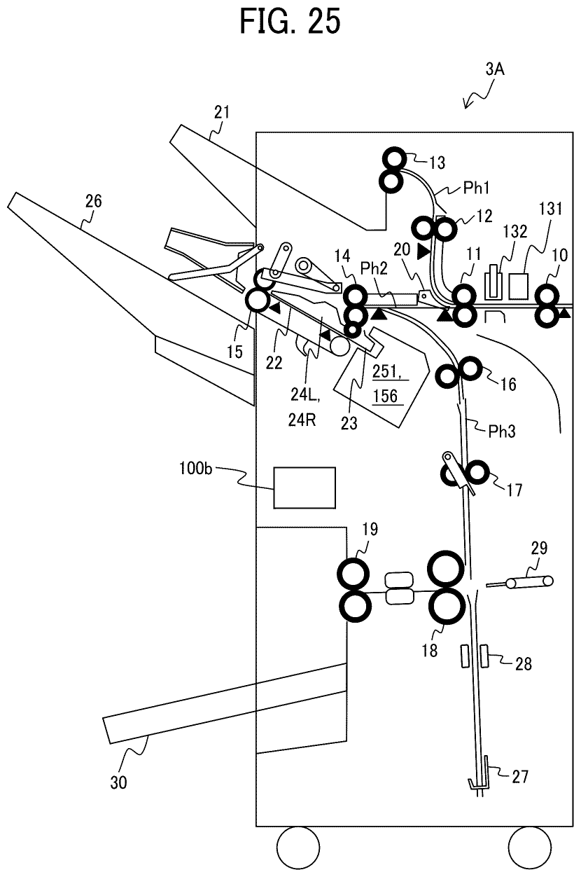

The post-processing apparatus 3A according to the second embodiment is described below with reference to FIGS. 25 to 33. In the following description, the same or similar components as those of the post-processing apparatus 3 according to the first embodiment are denoted by the identical or similar reference signs, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed at an upstream position in a direction in which a sheet P is conveyed. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as a “reverse conveyance direction” in the following description. A direction that is orthogonal to both the reverse conveyance direction and the thickness direction of the sheet P is defined as the “main scanning direction” or the “width direction of the sheet P.”

The liquid application position to which the liquid is applied on the sheet P or the sheet bundle Pb by the liquid applier 131 corresponds to the binding position on the sheet bundle Pb to be crimped and bound by the crimper 32′. For this reason, in the following description, the liquid application position and the binding position are described with the same reference sign (B1).

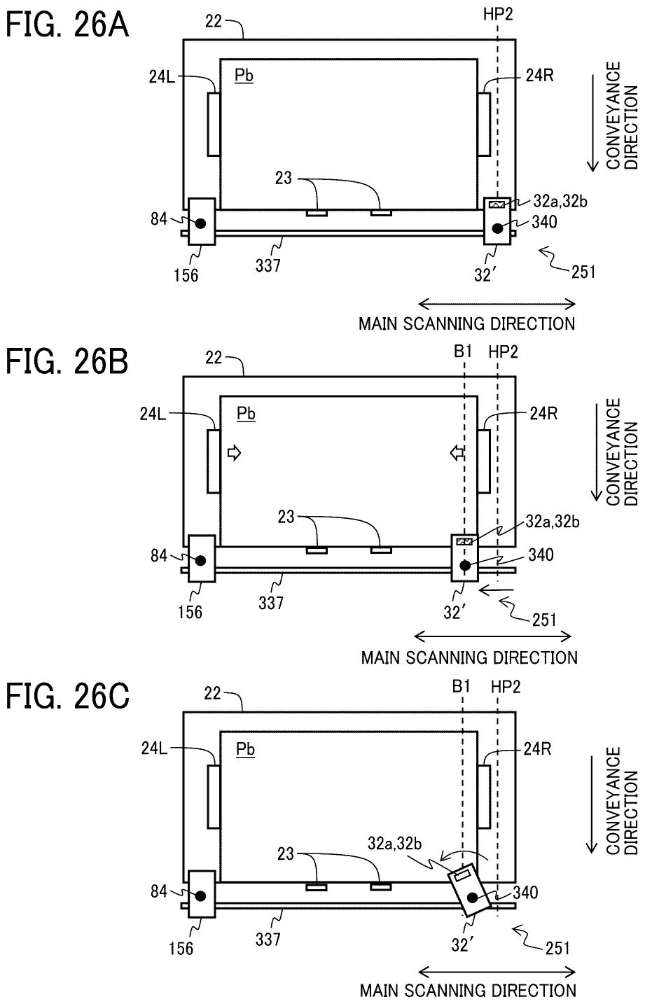

FIG. 25 is a diagram illustrating an internal configuration of the post-processing apparatus 3A according to the second embodiment. As illustrated in FIGS. 26A, 26B, and 26C, the edge binder 251 includes the crimper 32′. As illustrated in FIGS. 26A, 26B, and 26C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at any desired angle, any desired position in the main scanning direction on the sheet stack Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22, thus allowing the sheet bundle Pb to be stapled.

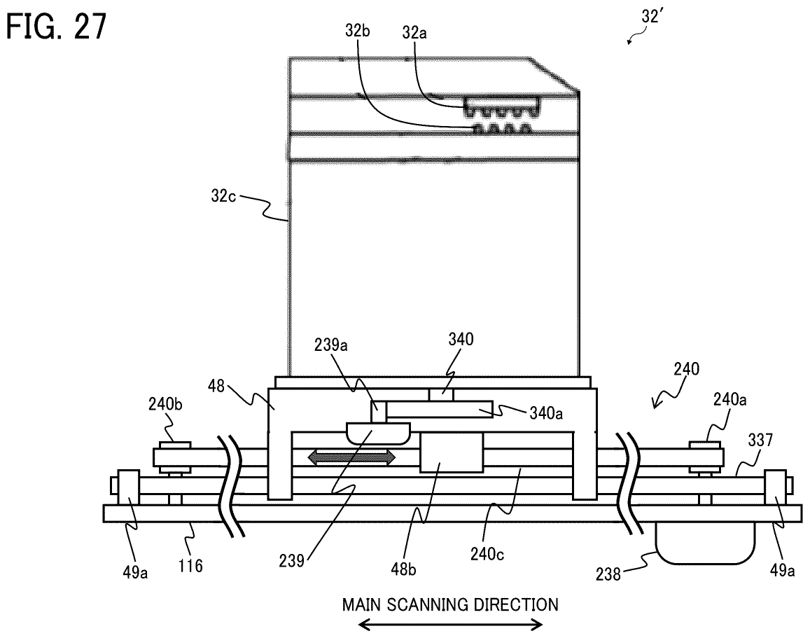

Each of FIGS. 26A, 26B, and 26C is a view of the internal tray 22 in the thickness direction of the sheet bundle Pb. FIG. 27 is a schematic diagram illustrating a downstream side of the crimper 32′ in the conveyance direction. As illustrated in FIGS. 26A, 26B, and 26C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about a crimper shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in thickness direction of the sheet bundle Pb. The other components of the staple binder 156 are similar to, even if not the same as, those of the staple binder 155 (see FIG. 9) of the post-processing apparatus 3 according to the first embodiment. For this reason, a detailed description thereof is omitted.

As illustrated in FIG. 27, the crimper 32′ includes a guide rail 337 extending in the main scanning direction at a position downstream from the internal tray 22 in the conveyance direction. The crimper 32′ includes a crimper movement motor 238 as a driving source. A base 48 supporting a crimping frame 32c has a fastening portion 48b for a timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimping frame 32c that holds the components of the crimper 32′.

The crimper shaft 340 and the drive transmission gear 340a are held by a base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of an example of a driving assembly of the crimper 32′.

The crimper 32′ is movable between a standby position HP2 illustrated in FIG. 26A and a position where the crimper 32′ faces the binding position B1 illustrated in FIGS. 26B and 26C. The standby position HP2 is a position away in the main scanning direction from the sheet bundle Pb placed on the internal tray 22. The binding position B1 is a position on the sheet bundle Pb placed on the internal tray 22. However, the specific position of the binding position B1 is not limited to the position illustrated in FIGS. 26B and 26C. The binding position B1 may be any one or more positions along the main scanning direction at the downstream end, in the conveyance direction, of the sheet P.

The posture of the crimper 32′ changes or is pivoted between a parallel binding posture illustrated in FIG. 26B and an oblique binding posture illustrated in FIG. 26C. In other words, the crimper 32′ is rotatable in the forward and reverse directions about the crimper shaft 340. The parallel binding posture is a posture of the crimper 32′ in which the length of the upper crimping teeth 32a and the lower crimping teeth 32b (in other words, a rectangular crimping trace) is along the main scanning direction. The oblique binding posture is a posture of the crimper 32′ in which the length of the upper crimping teeth 32a and the lower crimping teeth 32b (in other words, the rectangular crimping trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 26C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the reverse conveyance direction. In addition, the liquid applier 131 and the hole punch 132 are disposed at different positions in the reverse conveyance direction to simultaneously face one sheet P that is conveyed by the conveyance roller pairs 10 to 19.

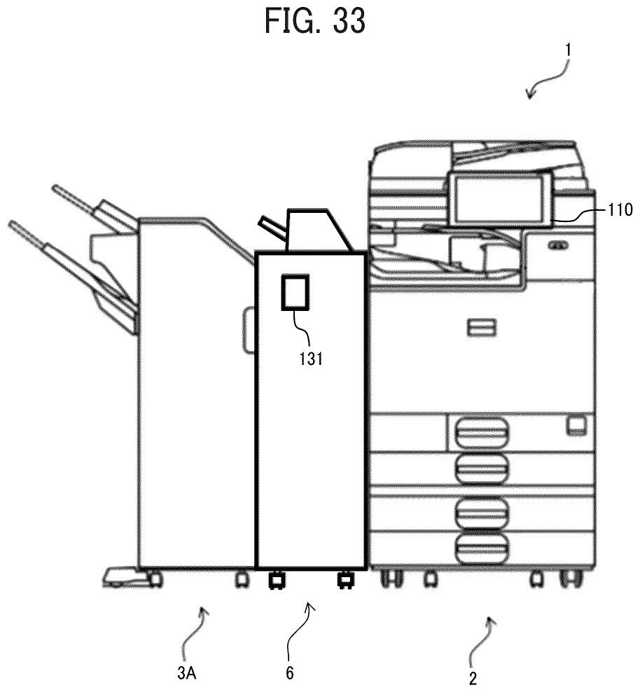

The liquid applier 131 and the hole punch 132 according to the present embodiment are disposed between the conveyance roller pairs 10 and 11. However, the arrangement of the liquid applier 131 is not limited to the example of FIG. 25. For example, in a case where an inserter 6 is disposed between the image forming apparatus 2 and the post-processing apparatus 3A as illustrated in FIG. 33, the liquid applier 131 may be disposed inside the inserter 6 located upstream from the post-processing apparatus 3A in a direction in which the sheet P is conveyed from the image forming apparatus 2 to the post-processing apparatus 3A. An example of the inserter 6 is an apparatus that allows a pre-printed medium, which is conveyed to the post-processing apparatus 3A together with the sheet P conveyed from the image forming apparatus 2, to be fed as a cover sheet, an insertion sheet, or a partition sheet without passing through the image forming apparatus 2.

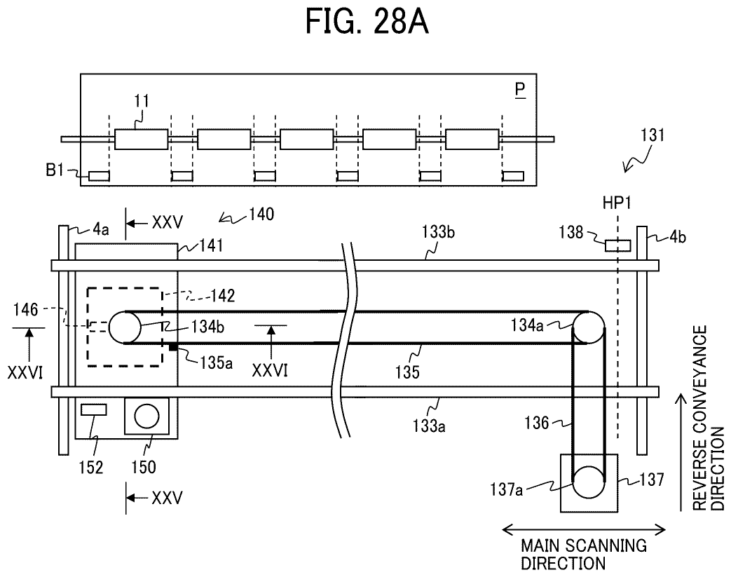

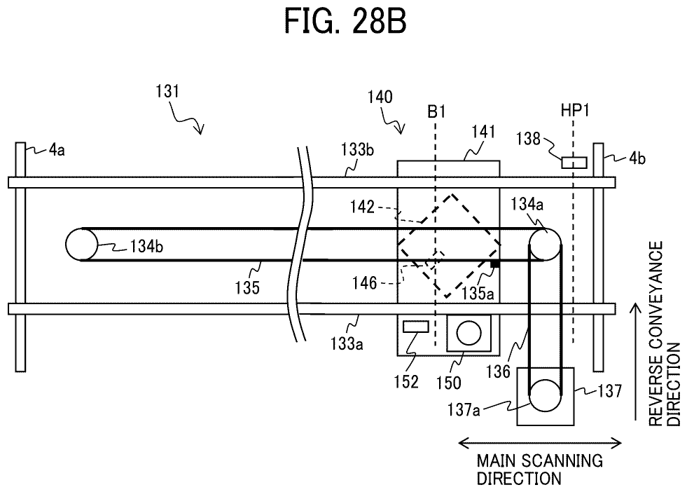

As illustrated in FIG. 28A, the conveyance roller pair 11 is located so as not to overlap, in the main scanning direction, with the liquid application position B1 on the sheet P to which the liquid is applied by a liquid application head 146 of the liquid applier 131. This arrangement is to prevent the amount of liquid at the liquid application position B1 from decreasing due to the multiple paired rollers pressing the liquid application position B1 when the conveyance roller pair 11 conveys the sheet P. As a result, when the sheet P reaches the crimper 32′ disposed downstream from the liquid applier 131 in the reverse conveyance direction, the amount of liquid at the liquid application position B1 is sufficient to maintain the binding strength. Accordingly, the binding strength of the sheet bundle Pb is prevented from decreasing due to a decrease in the amount of liquid at the liquid application position B1 (corresponding to the binding position B1) while the sheet P is conveyed.

In addition, the multiple paired rollers of the conveyance roller pair 11 that are located so as not to overlap the liquid application position B1 on the sheet P in the main scanning direction can prevent the conveying performance of the sheet P from being worse due to the adhesion of liquid to the multiple paired rollers and further prevents a conveyance jam caused by the worsened conveying performance of the sheet P.

Although only the conveyance roller pair 11 has been described above, the multiple paired rollers of the conveyance roller pairs 14 and 15 are preferably located so as not to overlap the liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

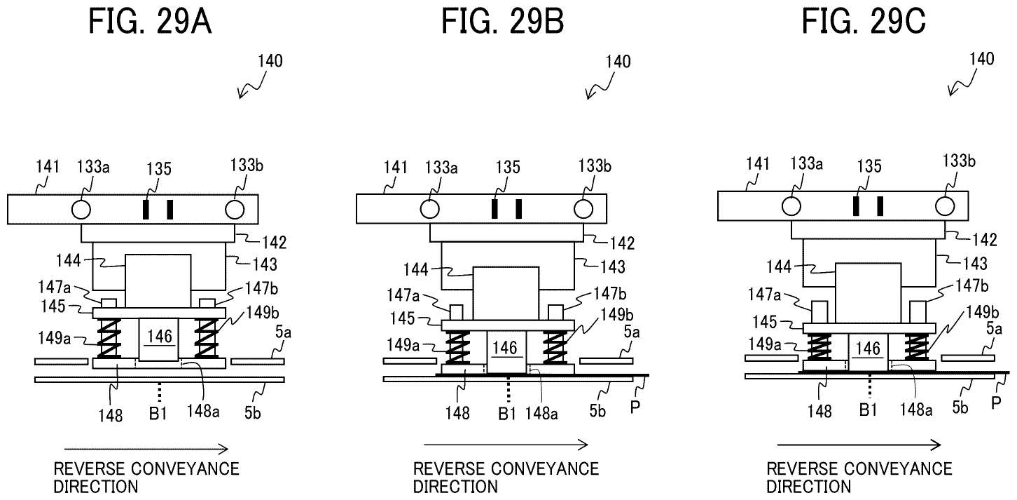

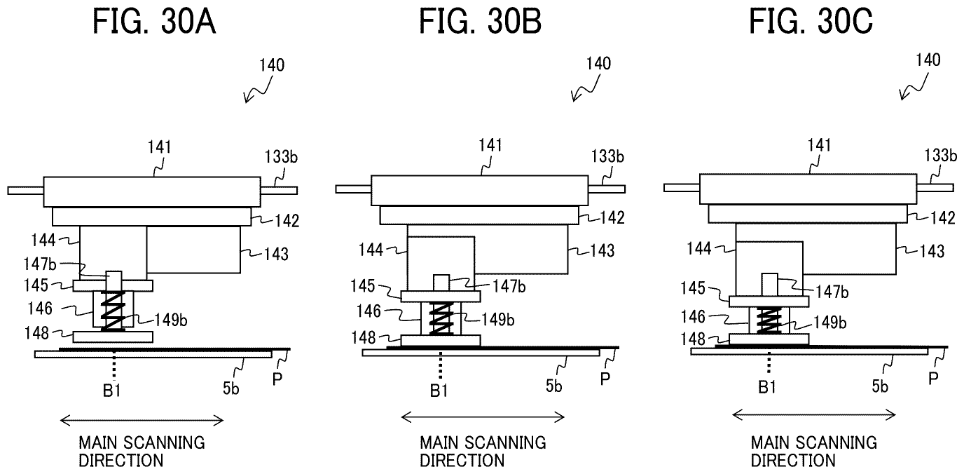

FIGS. 28A and 28B are views of the liquid applier 131 in the thickness direction of the sheet P, according to the second embodiment. FIGS. 29A, 29B, and 29C are cross-sectional views of the liquid applier 131 taken along line XXV-XXV of FIG. 28A. FIGS. 30A, 30B, and 30C are cross-sectional views of the liquid applier 131 taken along line XXVI-XXVI of FIG. 28A. As illustrated in FIGS. 28A to 30C, the liquid applier 131 includes a pair of guide shafts 133a and 133b, a pair of pulleys 134a and 134b, endless annular belts 135 and 136, a liquid-applier movement motor 137, a standby position sensor 138, and the liquid application unit 140.

The pair of guide shafts 133a and 133b each extend in the main scanning direction at positions spaced apart from each other in the reverse conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the reverse conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is entrained around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to the rotation direction of the liquid-applier movement motor 137 being switched.

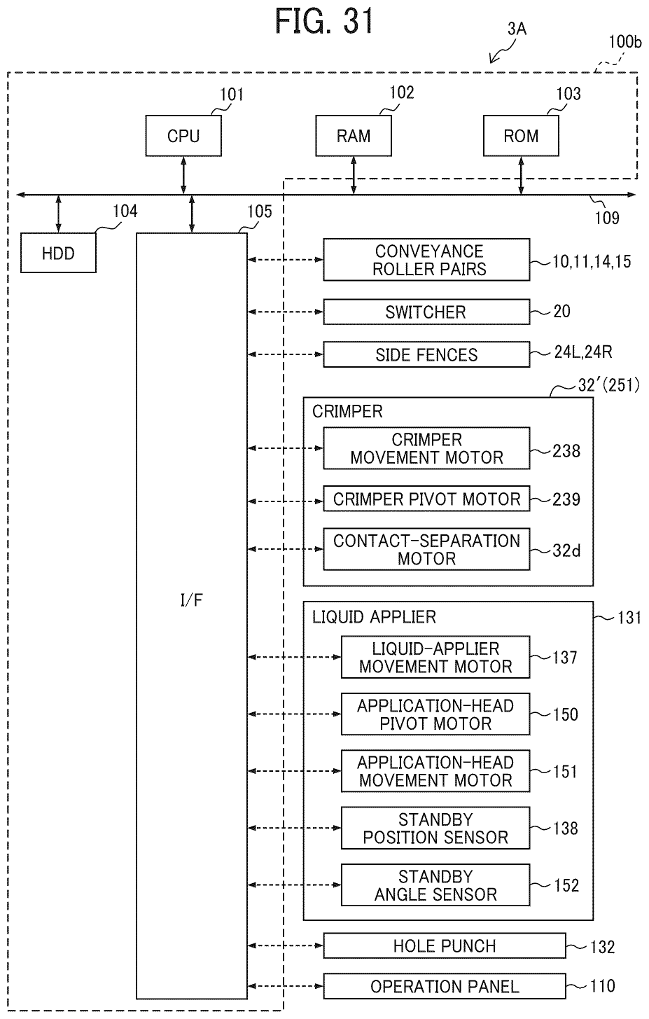

The standby position sensor 138 detects that the liquid application unit 140 has reached a standby position HP1 (see FIGS. 28A and 28B) in the main scanning direction. The standby position sensor 138 then outputs a standby position signal indicating the detection result to the controller 100b, which will be described below with reference to FIG. 31. The standby position sensor 138 is, for example, an optical sensor including a light emitter and a light receiver. The liquid application unit 140 at the standby position blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 29A to 29C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance passage (a position at which the liquid application unit 140 can face the sheet P) through the opening of the upper guide plate 5a.

As illustrated in FIGS. 28A to 30C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, the application-head pivot motor 150, the application-head movement motor 151 (see FIG. 31), and a standby angle sensor 152 (see FIG. 31).

The base 141 is supported by the pair of guide shafts 133a and 133b so as to be slidable in the main scanning direction. The base 141 is coupled to the endless annular belt 135 by the connection 135a. The base 141 supports the components 142 to 152 of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application-head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152, which is also illustrated in FIG. 31, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 28A illustrates the rotary bracket 142 in a position for the parallel binding that is performed by the crimper 32′ disposed downstream from the liquid applier 131 in a direction in which the sheet P is conveyed. FIG. 28B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid-application-head mover 144 is attached to the liquid storage tank 143 so as to be movable (e.g., up and down) in the thickness direction of the sheet P. The liquid-application-head mover 144 moves with respect to the liquid storage tank 143 by a driving force transmitted from the application-head movement motor 151. The holder 145 is attached to a lower end of the liquid-application-head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b are movable with respect to the holder 145 relatively in the thickness direction. The columns 147a and 147b hold the pressure plate 148 at lower ends thereof. The pressure plate 148 has a through hole 148a at a position to face the liquid application head 146. The coil springs 149a and 149b are inserted to the outsides of the columns 147a and 147b between the holder 145 and the pressure plate 148. The coil springs 149a and 149b bias the columns 147a and 147b and the pressure plate 148 in a direction away from the holder 145.

As illustrated in FIGS. 29A and 30A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the liquid application position B1 on the sheet P faces the opening, the application-head movement motor 151 is rotated in a first direction. As a result, the liquid-application-head mover 144, the holder 145, the liquid application head 146, the columns 147a and 147b, the pressure plate 148, and the coil springs 149a and 149b move down together, and the pressure plate 148 contacts the sheet P. The liquid application position B1 corresponds to the binding position B1 to be crimped and bound by the edge binder 251, specifically, the crimper 32′.

As the application-head movement motor 151 keeps rotating in the first direction even after the pressure plate 148 contacts the sheet P, the coil springs 149a and 149b are compressed to further move down the liquid-application-head mover 144, the holder 145, the liquid application head 146, and the columns 147a and 147b. As a result, as illustrated in FIGS. 29B and 30B, a lower face of the liquid application head 146 contacts the sheet P through the through hole 148a. As a result, the liquid contained in the liquid application head 146 is applied to the sheet P.

Further rotation of the application-head movement motor 151 in the first direction further strongly presses the liquid application head 146 against the sheet P as illustrated in FIGS. 29C and 30C. Accordingly, the amount of liquid applied to the sheet P increases. In short, the liquid applier 131 changes the pressing force of the liquid application head 146 against the sheet P to adjust the amount of liquid that is applied to the sheet P.

On the other hand, the rotation of the application-head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIGS. 29A and 30A, the liquid application head 146 and the pressure plate 148 are separated from the sheet P. In other words, the liquid applier 131 includes the liquid application head 146 that can be separated from the sheet P.

FIG. 31 is a block diagram illustrating a hardware configuration of the post-processing apparatus 3A to control the operation of the post-processing apparatus 3A according to the second embodiment. As illustrated in FIG. 31, the post-processing apparatus 3A has a configuration in which a central processing unit (CPU) 101, a random-access memory (RAM) 102, a read-only memory (ROM) 103, a hard disk drive (HDD) 104, and an interface (I/F) 105 are connected via a common bus 109.

The CPU 101 is an arithmetic device and controls the overall operation of the post-processing apparatus 3A. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. With such processing, a software controller including various functional modules of the post-processing apparatus 3A is configured. The software controller thus configured is combined with hardware resources of the post-processing apparatus 3A mounted in the post-processing apparatus 3A to configure functional blocks that implement functions of the post-processing apparatus 3A. In other words, the CPU 101, the RAM 102, the ROM 103, the HDD 104, and the I/F 105 constitute at least part of the controller 100b (control device) that controls the operation of the post-processing apparatus 3A.

The I/F 105 is an interface that connects the conveyance roller pairs 10, 11, 14, and 15, the switcher 20, the side fences 24L and 24R, the crimper movement motor 238, the crimper pivot motor 239, a contact-separation motor 32d, a liquid-applier movement motor 137, an application-head pivot motor 150, an application-head movement motor 151, a standby position sensor 138, a standby angle sensor 152, a hole punch 132, and an operation panel 110 to the common bus 109.

The controller 100b controls, via the I/F 105, the operations of the conveyance roller pairs 10, 11, 14, and 15, the switcher 20, the side fences 24L and 24R, the crimper movement motor 238, the crimper pivot motor 239, the contact-separation motor 32d, the liquid-applier movement motor 137, the application-head pivot motor 150, the application-head movement motor 151, and the hole punch 132. The controller 100b acquires detection results from the standby position sensor 138 and the standby angle sensor 152 through the I/F 105.

Although FIG. 31 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 33, the image forming apparatus 2 includes the operation panel 110. The operation panel 110 includes an operation device that receives instructions input by a user and a display (which is an example of a notifier) that notifies the user of information. The operation device includes, for example, hard keys and a touch screen overlaid on the display. The operation panel 110 acquires information from the user through the operation device and provides information to the user through the display. The post-processing apparatus 3A may include an operation panel 110 similar to the above-described operation panel 110.

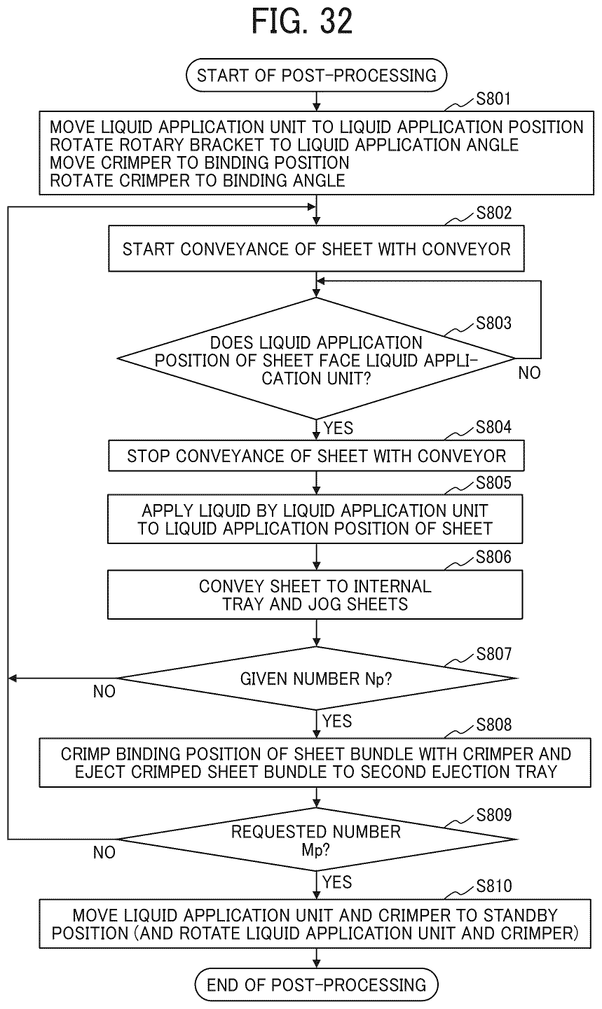

FIG. 32 is a flowchart of post-processing performed by the post-processing apparatus 3A according to the second embodiment. Specifically, FIG. 32 is a flowchart of a process to execute the one-point binding illustrated in FIGS. 26A to 26C.

For example, the controller 100b executes the post-processing illustrated in FIG. 32 in response to acquisition of an instruction (denoted below as “post-processing command”) of executing the post-processing from the image forming apparatus 2. The post-processing command includes, for example, the number of sheets P of the sheet bundle Pb (referred to as “given number of sheet Np”), the number of sheet bundles Pb to be subjected to binding process (referred to as “requested number of copies Mp”), the binding position B1 (corresponding to the liquid application position B1), the angle of the binding position B1 (corresponding to the angle of the liquid application position B1), the type of binding process (parallel binding process or oblique binding process), and a process that is executed in parallel with the liquid application process (i.e., punching a hole in the present embodiment). At the start of the post-processing, the liquid application unit 140 is at the standby position HP1 illustrated in FIGS. 28A to 28C, and the rotary bracket 142 is held at the standby angle (corresponding to the parallel binding posture) at the standby position HP1.

First, in step S801, the controller 100b drives the liquid-applier movement motor 137 to move the liquid application unit 140 (corresponding to a liquid applier) in the main scanning direction such that a liquid application head 146 moves from the standby position HP1 to a position where the liquid application head 146 can face the liquid application position B1 (see FIG. 28B, the position corresponding to the binding position B1 illustrated in FIGS. 26A to 26C). If the type of the binding process instructed by the post-processing command is “oblique binding process,” in step S801, the controller 100b drives the application-head pivot motor 150 to rotate the rotary bracket 142. Thus, the liquid application head 146 is rotated from the standby angle to the liquid application angle corresponding to the “oblique binding posture.” It is ascertained based on a pulse signal output from a rotary encoder of the liquid-applier movement motor 137 that the liquid application head 146 has reached the position where the liquid application head 146 can face the liquid application position B1. Similarly, it is ascertained based on a pulse signal output from a rotary encoder of the application-head pivot motor 150 that the liquid application head 146 has reached the liquid application angle. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, in step S801, the controller 100b drives the crimper movement motor 238 to move the crimper 32′ from the standby position HP2 to the position where the crimper 32′ can face the binding position B1 as illustrated in FIGS. 26A and 26B. Alternatively, if the type of the binding process instructed by the post-processing command is “oblique binding process,” in step S801, the controller 100b drives the crimper pivot motor 239 to rotate the crimper 32′ from the standby angle to the crimping angle corresponding to the “oblique binding posture.” It is ascertained based on a pulse signal output from a rotary encoder of the crimper movement motor 238 that the crimper 32 has reached the position where the crimper 32 can face the binding position B1. Similarly, it is ascertained based on a pulse signal output from a rotary encoder of the crimper pivot motor 239 that the crimper 32 has reached the crimp binding angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

In step S802, the controller 100b drives the conveyance roller pairs 10 and 11 to start conveying the sheet P on which an image is formed by the image forming apparatus 2. In step S803, the controller 100b determines whether the liquid application position B1 on the sheet P has faced the liquid application unit 140 (more specifically, the liquid application head 146). When the controller 100b determines that the liquid application position B1 on the sheet P has not faced the liquid application unit 140 (NO in S803), the controller 100b continues causing the conveyance roller pairs 10 and 11 to convey the sheet P until the liquid application position B1 on the sheet P faces the liquid application unit 140 (YES in S803). When the controller 100b determines that the liquid application position B1 on the sheet P has faced the liquid application head 146 (YES in step S803), in step S804, the controller 100b causes the conveyance roller pairs 10 and 11 to stop conveying the sheet P. It is ascertained, based on a pulse signal output from a rotary encoder of a motor that drives the conveyance roller pairs 10 and 11, that the liquid application position B1 on the sheet P has faced the liquid application head 146.

In step S805, the controller 100b causes the liquid application unit 140 to execute the process of applying liquid to the liquid application position B1 on the sheet P. More specifically, the controller 100b rotates the application-head movement motor 151 in the first direction to bring the liquid application head 146 into contact with the liquid application position B1 on the sheet P. The controller 100b changes the pressing force of the liquid application head 146 (i.e., the amount of rotation of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application-head movement motor 151 can be ascertained based on a pulse signal output from a rotary encoder of the application-head movement motor 151.

In step S806, the controller 100b drives the conveyance roller pairs 10, 11, 14, and 15 to place a sheet P on the internal tray 22. The controller 100b moves the side fences 24L and 24R to align the position of the sheet P or the sheet bundle Pb placed on the internal tray 22 in the main scanning direction in step S806. In short, the controller 100b performs so-called jogging.

In step S807, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), in step S808, the controller 100b causes the crimper 32′ to crimp the binding position B1 (corresponding to the liquid application position B1) on the sheet stack Pb to which the liquid has been applied by the liquid application unit 140. In addition, in step S808, the controller 100b rotates the conveyance roller pair 15 to eject the crimped sheet bundle Pb to the ejection tray 26.

In step S809, the controller 100b determines whether the number of sheet bundles Pb thus ejected to the ejection tray 26 has reached the requested number of copies Mp indicated by the binding command. When the controller 100b determines that the number of the sheet stacks Pb ejected to the ejection tray 26 has not reached the requested number of copies Mp (NO in step S809), the controller 100b repeats the processing of steps S802 to S809 until the number of the sheet stacks Pb ejected to the ejection tray 26 reaches the requested number of copies Mp (YES in step S809).

When the controller 100b determines that the number of sheet stacks Pb ejected to the ejection tray 26 reaches the requested number of copies Mp (YES in step S809), in step S810, the controller 100b drives the liquid-applier movement motor 137 to move the liquid application unit 140 to the standby position HP1 (see FIGS. 26B) and drives the crimper movement motor 238 to move the crimper 32′ to the standby position HP2 (see FIG. 26A). When the posture that is instructed by the post-processing operation is the “oblique binding posture,” in step S810, the controller 100b drives the application-head pivot motor 150 and the crimper pivot motor 239 to rotate the liquid application unit 140 and crimper 32′ and the parallel binding posture (standby angle) into the parallel binding posture. By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S801 and S810, the execution order of the movement in the main scanning direction and the rotation in the forward and reverse directions of the liquid application unit 140 and the crimper 32′ is not limited to the aforementioned order and may be reversed.

The present disclosure can be applied to not only the edge binder 25 that executes edge binding but also to the saddle binder 28 that executes saddle stitching.

The controller 100b of the post-processing apparatus 3A according to the second embodiment illustrated in FIG. 25 is provided separately from the controller 100a of the image forming apparatus 2 as in the configuration of FIG. 1. However, embodiments of the present disclosure are not limited to the above-described configuration. For example, as illustrated in FIG. 34A, the controller 100b of the post-processing apparatus 3A may be disposed in the image forming apparatus 2. Further, as in the configuration of FIG. 34B, the controller 100b of the post-processing apparatus 3A may be integrated with the controller 100a of the image forming apparatus 2.

As in the configuration of FIG. 35A, the controller 100b of the post-processing apparatus 3A may be divided into a controller 100b1 (e.g., a driver system such as a motor) and a controller 100b2 (a detector such as a sensor) according to the function, and the controller 100b2 of the post-processing apparatus 3A may be disposed in the image forming apparatus 2. Further, as in the configuration of FIG. 35B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

The present disclosure is not limited to the above-described embodiments, and numerous additional modifications and variations are possible in light of the teachings within the technical scope of the appended claims. It is therefore to be understood that the above-described embodiments of the present disclosure may be practiced otherwise by those skilled in the art than as specifically described herein. Such modifications are included in the technical scope described in the scope of claims.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The aspects of the present disclosure are, for example, as follows.

### First Aspect

a liquid applier to apply liquid to at least one medium;
a post-processing device to perform post-processing on a plurality of media including the medium to which the liquid has been applied by the liquid applier; and
a movement assembly to move the liquid applier and the post-processing device in a width direction of the medium; and
a first liquid storage that is mounted on the liquid applier to store the liquid applied to the medium;
a second liquid storage to store the liquid supplied to the first liquid storage;
a liquid supply passage through which the liquid is supplied from the second liquid storage to the first liquid storage; and
a controller to control the movement assembly. The controller stops the movement assembly when a load of a driving source of the movement assembly exceeds a threshold.

### Second Aspect

The medium processing apparatus according to the first aspect includes a notifier to notify a user of information.

The controller notifies freezing of the liquid supply passage through the notifier when the load of the driving source exceeds the threshold.

### Third Aspect

The medium processing apparatus according to the second aspect further includes an operation device to receive a user operation. The controller notifies freezing of the liquid supply passage through the notifier when the load of the driving source exceeds the threshold in a state in which a user operation indicating use of the medium processing apparatus in a cold region is received through the operation device.

### Fourth Aspect

In the medium processing apparatus according to the third aspect, the controller notifies an abnormality of the medium processing apparatus through the notifier when the load of the driving source exceeds the threshold in a state in which the user operation indicating the use of the medium processing apparatus in the cold region is not received through the operation device.

### Fifth Aspect

In the medium processing apparatus according to any one of the first to fourth aspects, the movement assembly includes a guide shaft that extends in the width direction of the medium and guides movement of the liquid applier and the post-processing device, and the liquid supply passage is a coil tube that is spirally wound around the guide shaft to expand and contract.

### Sixth Aspect

In the medium processing apparatus according to any one of the first to fifth aspects, the post-processing device is a crimping device to press and deform the plurality of media to bind the plurality of media.

### Seventh Aspect

An image forming system includes: an image forming apparatus to form an image on the medium; and the medium processing apparatus according to any one of the first to sixth aspects to perform the post-processing on the plurality of media on which the image is formed by the image forming apparatus.

1. A medium processing apparatus, comprising:
a liquid applier to apply liquid to a medium;
a post-processing device to perform post-processing on a plurality of media including the medium to which the liquid is applied by the liquid applier;
a movement assembly to move the liquid applier and the post-processing device in a width direction of the medium;
a first liquid storage on the liquid applier to store the liquid applied to the medium;
a second liquid storage to store the liquid supplied to the first liquid storage;
a liquid supply passage through which the liquid is supplied from the second liquid storage to the first liquid storage; and
processing circuitry configured to control the movement assembly,
wherein the processing circuitry is configured to stop the movement assembly when a load of a driving source of the movement assembly exceeds a threshold.

2. The medium processing apparatus according to claim 1, further comprising a notifier to notify a user of information,
wherein the processing circuitry is configured to notify freezing of the liquid supply passage through the notifier when the load of the driving source exceeds the threshold.

3. The medium processing apparatus according to claim 2, further comprising an operation device to receive a user operation,
wherein the processing circuitry is configured to notify freezing of the liquid supply passage through the notifier when the load of the driving source exceeds the threshold in a state in which a user operation indicating use of the medium processing apparatus in a cold region is received through the operation device.

4. The medium processing apparatus according to claim 3,
wherein the processing circuitry is configured to notify an abnormality of the medium processing apparatus through the notifier when the load of the driving source exceeds the threshold in a state in which the user operation indicating the use of the medium processing apparatus in the cold region is not received through the operation device.

5. The medium processing apparatus according to claim 1,
wherein the movement assembly includes a guide shaft that extends in the width direction of the medium and guides movement of the liquid applier and the post-processing device, and the liquid supply passage is a coil tube that is spirally wound around the guide shaft to expand and contract.

6. The medium processing apparatus according to claim 1,
wherein the post-processing device is a crimper to press and deform the plurality of media to bind the plurality of media.

7. An image forming system, comprising:
an image forming apparatus to form an image on media constituting the plurality of media; and
the medium processing apparatus according to claim 1 to perform the post-processing on the plurality of media on which the image is formed by the image forming apparatus.
